(19) United States
(12) Patent Application Publication
(10) Pub. No.: US 2020/0395585 A1
(43) Pub. Date: Dec. 17, 2020

(54) LITHIUM-COATED SEPARATORS AND ELECTROCHEMICAL CELLS COMPRISING THE SAME

(71) Applicant: Sion Power Corporation, Tucson, AZ (US)

(72) Inventors: Michael G. Laramie, Tucson, AZ (US); Chariclea Scordilis-Kelley, Tucson, AZ (US); Tracy Earl Kelley, Tucson, AZ (US); Yuriy V. Mikhaylik, Tucson, AZ (US); Robert S. Jung, Oro Valley, AZ (US)

(73) Assignee: Sion Power Corporation, Tucson, AZ (US)

(21) Appl. No.: 16/057,050

(22) Filed: Aug. 7, 2018

Related U.S. Application Data
(60) Provisional application No. 62/542,080, filed on Aug. 7, 2017.

(51) Int. Cl. H01M 2/16; H01M 10/0525; H01M 4/587; H01M 4/485

(52) U.S. Cl. CPC H01M 2/1686; H01M 10/0525; H01M 2/1653; H01M 4/587; H01M 4/485; H01M 2/1646

(57) ABSTRACT

The present disclosure is related to electrochemical cell components, electrochemical cells, and associated methods. According to certain embodiments, the electrochemical cell component may comprise a separator and a layer comprising lithium adhered to the separator. In some embodiments, the separator and layer comprising lithium may be positioned between two electrodes within an electrochemical cell. The use of such arrangements can, according to certain embodiments, allow for the facile introduction of supplemental lithium to an electrochemical cell in a manner that is compatible with existing electrochemical cell fabrication processes.

### RELATED APPLICATIONS

This application claims priority under 35 U.S.C. § 119(e) to U.S. Provisional Application No. 62/542,080, filed Aug. 7, 2017, and entitled “Lithium-Coated Separators and Electrochemical Cells Comprising the Same,” which is incorporated herein by reference in its entirety for all purposes.

### TECHNICAL FIELD

Electrochemical cells and associated methods are generally described.

### SUMMARY

The present disclosure is related to electrochemical cell components, electrochemical cells, and associated methods. According to certain embodiments, the electrochemical cell component may comprise a separator and a layer comprising lithium, sodium, and/or magnesium adhered to the separator. In some embodiments, the separator and layer comprising lithium and/or sodium and/or magnesium may be positioned between two electrodes within an electrochemical cell. The use of such arrangements can, according to certain embodiments, allow for the facile introduction of supplemental lithium to an electrochemical cell in a manner that is compatible with existing electrochemical cell fabrication processes. The subject matter of the present invention involves, in some cases, interrelated products, alternative solutions to a particular problem, and/or a plurality of different uses of one or more systems and/or articles.

In some embodiments, electrochemical cells are provided. An electrochemical cell may comprise a first electrode, a second electrode, and a composite comprising a separator and a layer comprising lithium disposed on a surface of the separator. In some embodiments, the composite is positioned between the first electrode and the second electrode, the layer comprising the lithium contains lithium in an amount of at least 50 wt %, the layer comprising the lithium is adhered to the separator, the first electrode is a lithium intercalation electrode, and/or the second electrode is a lithium intercalation electrode.

In some embodiments, an electrochemical cell comprises a first electrode, a second electrode, and a composite. The composite may comprise a polymeric electronically insulating separator and a layer comprising lithium disposed on a surface of the separator. In some embodiments, the composite is positioned between the first electrode and the second electrode, the layer comprising the lithium contains lithium in an amount of at least 50 wt %, and/or the layer comprising the lithium is adhered to the separator.

In some embodiments, composites for use in electrochemical cells are provided. A composite may comprise a polymeric electronically insulating separator and a layer comprising lithium in an amount of at least 50 wt % disposed on a surface of the separator. The layer comprising the lithium may be adhered to the separator. In some embodiments, methods of fabricating an electrochemical cell are provided. A method may comprise positioning, between a first electrode and a second electrode, a composite comprising a separator and a layer comprising lithium disposed on a surface of the separator. In some embodiments, the layer comprising the lithium contains lithium in an amount of at least 50 wt %. In some embodiments, the layer comprising the lithium is adhered to the separator.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows, in accordance with certain embodiments, a schematic illustration of a composite comprising a separator and a layer comprising lithium;

FIGS. 2A and 2B show, in accordance with certain embodiments, schematic illustrations of a layer;

FIG. 3A shows, in accordance with certain embodiments, a schematic illustration of an electrochemical cell comprising a composite, a first electrode, and a second electrode;

FIG. 3B shows, in accordance with certain embodiments, a schematic illustration of an electrochemical cell comprising a composite comprising a separator and a layer comprising lithium and/or sodium and/or magnesium, a first electrode, and a second electrode;

FIG. 3C shows, in accordance with certain embodiments, a schematic illustration of an electrochemical cell comprising a composite comprising a separator and two layers comprising lithium and/or sodium and/or magnesium, a first electrode, and a second electrode;

FIG. 3D shows, in accordance with certain embodiments, a schematic illustration of an electrochemical cell comprising optional current collectors and an optional containment structure;

FIG. 4 shows, in accordance with certain embodiments, a schematic illustration of a method for adding a composite to an electrochemical cell;

FIG. 5 shows, in accordance with certain embodiments, discharge capacity as a function of cycle for certain electrochemical cells; and

FIG. 6 shows, in accordance with further embodiments, discharge capacity as a function of cycle for certain electrochemical cells.

### DETAILED DESCRIPTION

Inventive electrochemical cell components, electrochemical cells, and associated methods are generally provided. In some embodiments, an electrochemical cell component may be provided that is capable of compensating for irreversible capacity loss within an electrochemical cell.

Certain electrochemical cells may suffer from irreversible capacity loss during initial cycling due to irreversible processes associated with initial intercalation of electrode active material into anode materials and initial solid electrolyte interface formation. Without wishing to be bound by theory, it is believed that irreversible capacity loss (a phenomenon in which electrochemical cells (e.g., lithium ion electrochemical cells, sodium ion electrochemical cells, magnesium ion electrochemical cells) display a higher capacity when first cycled and a lower capacity in subsequent cycles) may be due to irreversible reaction of a first electrode active material (e.g., lithium ions, sodium ions, magnesium ions) with a second electrode active material (e.g., a lithium ion intercalation anode active material, a sodium ion intercalation anode active material, a magnesium ion intercalation anode active material) and/or of an electrode active material with one or more electrolyte components to form a solid electrolyte interface (SEI). It is believed that the electrode active material that participates in these reactions is not removed from the anode during subsequent cell cycling, and so the initial capacity it provides during initial intercalation or SEI formation is irreversibly lost after the first cycle. As an example, if an electrochemical cell comprises a first electrode (e.g., a lithium ion intercalation anode, a sodium ion intercalation anode, a magnesium ion intercalation anode) and a second electrode (e.g., a lithium ion intercalation cathode, a sodium ion intercalation cathode, a magnesium ion intercalation cathode) that have equal capacity prior to cycling, the first cycle may make use of the full capacity of both the first electrode and the second electrode but subsequent cycles may not use the full capacity of the second electrode because some of the electrode active material originating from the second electrode has irreversibly reacted with or at the first electrode. An electrochemical cell with this property may be considered to have a second electrode with a larger reversible capacity than its first electrode. Electrochemical cells instead comprising first electrodes and second electrodes with roughly equal reversible capacities may have a higher capacity over a larger number of cycles, and/or may have an equivalent or higher reversible capacity at a lighter weight.

Adding a supplemental source of electrode active material into an electrochemical cell with irreversible capacity may compensate for initial capacity loss, but may be challenging to do economically in combination with existing electrochemical cell fabrication processes. Accordingly, compositions and methods that relate to compensating for irreversible capacity of one or more electrodes and that are compatible with existing electrochemical cell fabrication components, devices, and methods are desirable.

In some embodiments, an electrochemical cell component that can compensate for irreversible capacity loss by providing a source of electrode active material (e.g., a source of lithium ions, a source of sodium ions, a source of magnesium ions) and/or methods for its integration into an electrochemical cell are provided. The source of electrode active material may replace electrode active material that is consumed by irreversible reactions (e.g., irreversible reactions that occur during initial cell cycling).

In some embodiments, certain of the electrochemical cell components described herein are part of an electrochemical cell. In some such embodiments, the component(s) may be positioned in an electrochemical cell in a manner such that the component(s) at least partially compensates for irreversible capacity loss. The component(s) may at least partially compensate for irreversible capacity loss in a manner that provides a high energy density and/or high specific energy. For example, the component(s) may comprise a material in which the source of electrode active material is provided in a relatively pure form, and/or is provided in combination with other component(s) that may be minimal, lightweight, and/or have small volume(s).

In some embodiments, certain of the components described herein are provided as stand-alone components that are capable of being integrated into an electrochemical cell during electrochemical cell assembly. In some embodiments, it may be advantageous for the electrochemical cell component to be compatible with standard electrochemical cell assembly techniques (e.g., roll to roll coating), so that the component can be integrated into an electrochemical cell as part of an established production process at minimal additional cost. This may be accomplished by, for example, adhering the source of electrode active material (e.g., a layer comprising lithium and/or sodium and/or magnesium) to a standard electrochemical cell component (e.g., a separator) to form a composite that may be integrated into the electrochemical cell and that can be easily assembled with other electrochemical cell components using known processes to form an electrochemical cell.

As described above, certain embodiments are related to electrochemical cells. Electrochemical cells typically comprise a first electrode (e.g., an anode) and a second electrode (e.g., a cathode). In some embodiments, one or both of the first electrode and second electrode may be intercalation electrodes, which are electrodes that comprise a species capable of intercalating and deintercalating an electrode active species. For example, in some embodiments, the first electrode is an intercalation electrode. When the first electrode is an intercalation electrode, it may comprise a species capable of intercalating and deintercalating anode active species, such as a species capable of intercalating and deintercalating lithium (and/or sodium and/or magnesium). As another example, in some embodiments, the second electrode is an intercalation electrode (e.g., a lithium ion cathode, a sodium ion cathode, a magnesium ion cathode). When the second electrode is an intercalation electrode, it may comprise a species capable of intercalating and deintercalating a cathode active species. Further description of acceptable first and second electrode materials are provided below.

As used herein, electrode active materials are those materials associated with an electrode and which participate in the electrochemical reaction(s) of the electrochemical cell that generate electrical current. Cathode active materials are electrode active materials associated with the cathode of the electrochemical cell, and anode active materials are electrode active materials associated with the anode of the electrochemical cell. “Cathode” refers to the electrode in which an electrode active material is oxidized during charging and reduced during discharging, and “anode” refers to the electrode in which an electrode active material is reduced during charging and oxidized during discharging.

As also described above, certain embodiments are related to electrochemical cell components comprising a separator and/or electrochemical cells comprising a separator. As would be known to one of ordinary skill in the art, separators are electrochemical cell components that may be positioned between electrodes in order to spatially separate (and electronically insulate) them so that electronic short circuiting does not occur. Separators may be fabricated from a variety of materials and may have a variety of morphologies, as will be described in further detail below.

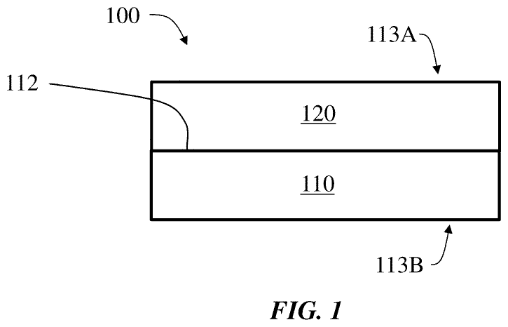

In some embodiments, electrochemical cell components that are composites are provided. A non-limiting example of a composite in accordance with certain embodiments is shown in FIG. 1. In FIG. 1, composite 100 comprises separator 110 and layer 120 comprising lithium disposed on surface 112 of separator 110.

Although layers comprising lithium are generally described, it should be understood that the separator may instead or additionally comprise a number of other suitable electrode active materials. For example, a layer comprising sodium and/or a layer comprising magnesium may disposed on the surface of the separator. A layer comprising sodium and/or magnesium may, in some embodiments, also comprise lithium.

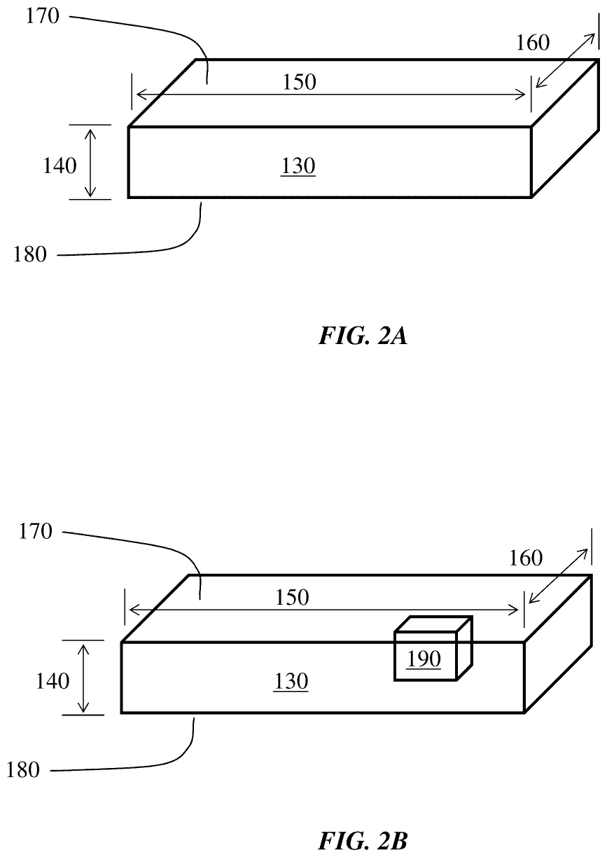

In some embodiments, an electrochemical cell or component as described herein may contain one or more layers (e.g., an electrochemical cell or component may contain one layer, two layers, three layers, or more layers). The layer(s) typically has a thickness and extends in two coordinate dimensions that are orthogonal to both each other and the thickness of the layer. In some embodiments, the thickness of a layer may be smaller than the other two coordinate dimensions of the layer (e.g., the thickness of the layer is less than 10%, less than 1%, or less than 0.1% of the extent of the layer in the other two coordinate dimensions). Layers also typically comprise at least two surfaces, which in some embodiments may be parallel surfaces. FIG. 2A shows one non-limiting embodiment of a layer 130 comprising thickness 140, coordinate dimensions 150 and 160, and surfaces 170 and 180. Layers may either be continuous (i.e., each portion of the layer is topologically connected to each other portion of the layer) or discontinuous (e.g., the layer may be made up of discrete components, such as islands).

In some embodiments, an electrochemical cell may comprise one or more layers that are single-material layer(s) (e.g., a layer comprising lithium and/or another suitable electrode active material such as sodium and/or magnesium may be a single material layer). A single material layer, in the context of the present disclosure, is a layer that is made up of a single material exclusively or almost exclusively. That is, a single material layer, in the context of the present disclosure, is a layer that is made up of at least 90 wt % of a single material. Examples of such single materials include, but are not limited to, a metal (such as lithium, sodium, or magnesium), a ceramic, an alloy, and a polymer. In some embodiments, the single-material layer is made up of at least 95 wt %, at least 99 wt %, or at least 99.9 wt % of the single material. Single materials are typically considered to be elements or compounds, and should not be understood to encompass composite materials (such as, e.g., particles held together by a binder). In some embodiments, a single material layer may be substantially free of particles (e.g., particles may make up less than 20 wt %, less than 10 wt %, less than 5 wt %, less than 1 wt %, or less than 0.1 wt % of the layer), and/or may be substantially free of binder (e.g., binder may make up less than 20 wt %, less than 10 wt %, less than 5 wt %, less than 1 wt %, or less than 0.1 wt % of the layer).

In some embodiments, a layer within an electrochemical cell or component may not be a single material layer, but may have a substantially uniform composition. (Single material layers typically also have substantially uniform compositions.) For instance, certain embodiments may relate to composites comprising a layer comprising lithium (and/or sodium and/or magnesium) that has a substantially uniform composition. A layer with a “substantially uniform composition,” as used in the present disclosure, is one in which no rectangular prism that contains 10% of the total volume of the layer can be drawn that includes, within its boundaries, a concentration of any component that is more than 20% different than the overall concentration of that component throughout the entirety of the layer. In some embodiments, no rectangular prism that contains 10% of the total volume of the layer can be drawn that includes, within its boundaries, a concentration of any component that is more than 10%, 5%, 2%, or 1% different than the overall concentration of that component throughout the entirety of the layer. FIG. 2B shows one non-limiting example of a layer with substantially uniform composition, where rectangular prism 190 within layer 130 occupies at least 10% of the total volume of layer 130 and comprises each component present within layer 130 at a concentration that is within 5% of the overall concentration for that component. It should be understood that although the rectangular prism in FIG. 2B is depicted as having an approximately cubic shape and is positioned near the center of layer 130, the concentrations of various components described above would also be true for other rectangular prisms within a layer with substantially uniform composition. For instance, prisms that include one elongated axis, prisms that include two elongated axes, prisms of other volumes, prisms which include surface(s) and/or edge(s) of the layer, and the like that also contain at least 10% of the total volume of a layer with substantially uniform composition would not have a concentration of any component that is more than 5% different than the overall concentration of that component throughout the entirety of that layer.

In some embodiments, an electrochemical cell may comprise one or more layers that do not have a substantially uniform composition (e.g., a first electrode, a second electrode). Such layer(s) may not have one or more of the characteristics described above.

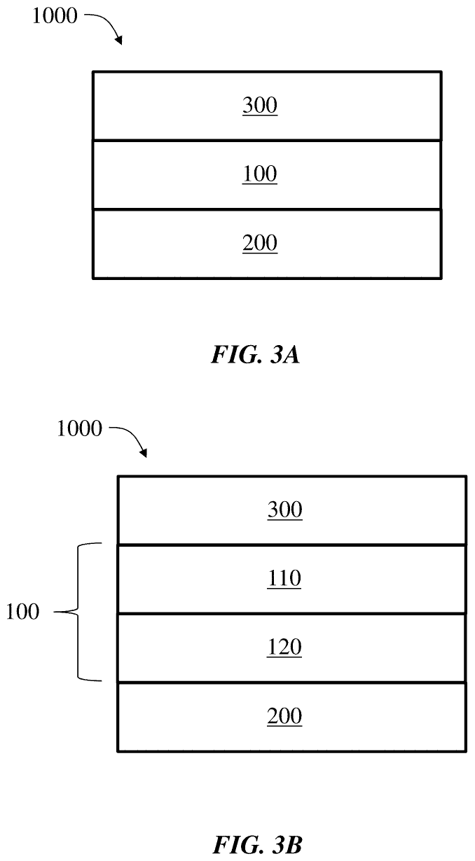

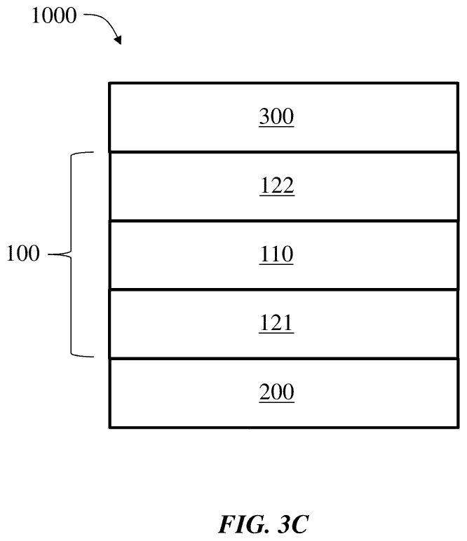

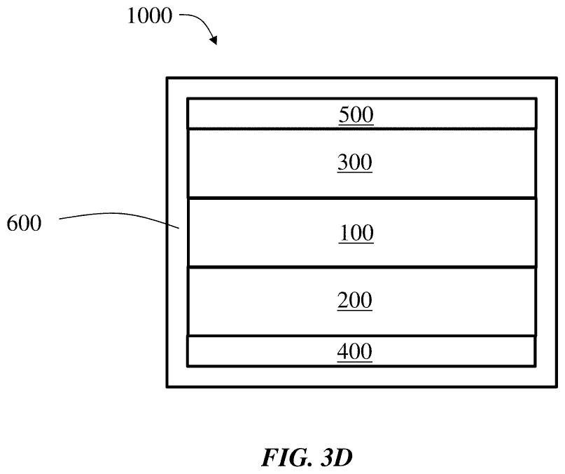

In some embodiments, a composite such as that shown in FIG. 1 may be one component of an electrochemical cell. In some embodiments, the composite is positioned between a first electrode of an electrochemical cell and a second electrode of the electrochemical cell. For instance, FIG. 3A shows electrochemical cell 1000 comprising composite 100 positioned between first electrode 200 and second electrode 300, in accordance with certain embodiments. In some embodiments, composite 100 as shown in FIG. 3A may have one or more of the properties associated with that of composite 100 as shown and described with respect to FIG. 1. It should be noted that while FIG. 3A shows the composite in direct contact with both the first electrode and the second electrode, other arrangements of the composite with respect to the first and the second electrode are also possible. For example, according to certain embodiments, one or more intervening cell components may be present between the first electrode and the composite, and/or between the composite and the second electrode. In some embodiments, one of the intervening cell component(s) may be an electrolyte, such as a liquid, gel, or solid electrolyte. In some embodiments, one of the intervening cell component(s) may be a porous ceramic layer, such as a boehmite layer. The porous ceramic layer, if present, may be a coating on the composite positioned between the portion of the composite beneath the coating and the first electrode or between the portion of the composite beneath the coating and the second electrode.

As used herein, a cell component that is positioned “between” two other cell components may be directly between the two other cell components such that no intervening cell component is present, or an intervening cell component may be present.

In some embodiments, a composite comprising a layer comprising lithium (and/or sodium and/or magnesium) disposed on a surface of a separator may be positioned in an electrochemical cell such that the surface of the separator on which the layer comprising the lithium (and/or sodium and/or magnesium) is disposed is a surface of the separator closest to the first electrode. One example of such an arrangement is shown illustratively in FIG. 3B. In FIG. 3B, composite 100 is positioned within electrochemical cell 1000 such that layer comprising the lithium (and/or sodium and/or magnesium) 120 is on the surface of separator 110 that is closest to first electrode 200. Without wishing to be bound by any theory, it is believed that placement of the composite within an electrochemical cell at this orientation may be advantageous (e.g., when the first electrode is an anode, such as a lithium intercalation anode), because it may allow the lithium (and/or sodium and/or magnesium) from the layer comprising the lithium (and/or sodium and/or magnesium) to be transported to the first electrode without traversing the separator.

The opposite configuration, or that where the surface of the separator on which the layer comprising the lithium (and/or sodium and/or magnesium) is disposed is a surface of the separator closest to the second electrode, is also contemplated, is also advantageous, and is also capable of effectively providing electrode active material to the first electrode. Electrochemical cells comprising a composite positioned such that the layer of the composite comprising the lithium is positioned closer to the cathode than the anode may unexpectedly perform as well as or better than electrochemical cells comprising a composite positioned such that the layer of the composite comprising the lithium is positioned closer to the anode. One of ordinary skill in the art would have expected that positioning a composite such that the layer comprising the lithium is closer to the cathode than the anode would have been undesirable for a variety of reasons. These reasons include: (1) the expectation that doing so would reduce the stability of the cathode active material by driving it to the anode voltage, (2) the expectation that doing so would result in less facile intercalation of the lithium into the anode than when the lithium is directly contacting the anode; and (3) the expectation that, because the separator extends for a larger spatial extent than the cathode, lithium positioned on portions of the separator around the cathode would not be intercalated into an electrode. However, unexpectedly, these effects were not observed.

In some embodiments, a composite may comprise a first layer comprising lithium (and/or sodium and/or magnesium) on the surface of the separator that is closest to the first electrode and comprise a second layer comprising lithium (and/or sodium and/or magnesium) on the surface of the separator that is closest to the second electrode. One example of such an arrangement is shown illustratively in FIG. 3C. In FIG. 3C, composite 100 comprising first layer comprising lithium (and/or sodium and/or magnesium) 121 and second layer comprising lithium (and/or sodium and/or magnesium) 122 is positioned within electrochemical cell 1000. Composite 100 is positioned within electrochemical cell 1000 such that first layer comprising the lithium (and/or sodium and/or magnesium) 121 is on the surface of separator 110 that is closest to first electrode 200 and such that second layer comprising the lithium (and/or sodium and/or magnesium) 122 is on the surface of separator 110 that is closest to second electrode 300. In cases where the composite comprises a first layer comprising lithium (and/or sodium and/or magnesium) on the surface of the separator that is closest to the first electrode and comprises a second layer comprising lithium (and/or sodium and/or magnesium) on the surface of the separator that is closest to the second electrode, typically one or both of the first layer comprising lithium (and/or sodium and/or magnesium) and the second layer comprising lithium (and/or sodium and/or magnesium) are porous and/or are relatively ionically conductive. In some such embodiments, one or both of the first layer comprising lithium (and/or sodium and/or magnesium) and the second layer comprising lithium (and/or sodium and/or magnesium) may have a thickness of greater than or equal to 1 micron and less than or equal to 2 microns. Other arrangements of a composite comprising a layer comprising lithium disposed on a separator are also possible.

In some embodiments, electrochemical cells including a composite separator that provides a source of electrode active material (e.g., lithium, sodium, magnesium) may be capable of compensating for irreversible capacity loss of at least one of the first electrode and the second electrode. In some embodiments, the source of electrode active material compensates for the irreversible capacity of a first electrode that is an anode. In such embodiments, the second electrode (e.g., cathode) and first electrode (e.g., anode) may initially have unequal capacities and/or unequal reversible capacities, but may obtain equal reversible capacities after initial cycling. As an example, an electrochemical cell may comprise a cathode with a cathodic reversible capacity and a cathodic irreversible capacity, an anode with an anodic reversible capacity and an anodic irreversible capacity, and a source of electrode active material in the form of a layer comprising the electrode active material disposed on a separator. During initial charging (e.g., during initial lithiation of the anode), the cathode may discharge to its full reversible capacity. This process alone may not provide sufficient electrode active material to satisfy the full anodic reversible capacity and the full anodic irreversible capacity, and so the anode may receive both electrode active material that originates from the cathode and electrode active material that originates from the layer comprising the electrode active material. The electrode active material originating from both of these layers together may provide sufficient electrode active material to satisfy the full capacity of the anode. Then, during discharge the anode may release electrode active material until its reversible capacity is exhausted. If the amount of electrode active material in the layer comprising the electrode active material, the amount of electrode active material that may be released from the cathode as part of its irreversible capacity, and the full capacity (irreversible and reversible) of the anode are correctly balanced, then the reversible capacity of the anode may match the reversible capacity of the cathode and the irreversible capacity of the anode may match the amount of electrode active material capable of being released from the layer comprising the electrode active material. In such cases, a ratio of reversible electrochemical cell capacity to electrochemical cell weight may be achieved. In otherwise equivalent electrochemical cells lacking a source of electrode active material, the full reversible capacity of the cathode and/or the anode may not be realized, and so the electrochemical cells will provide less reversible capacity at a higher weight. It should also be understood that in some cases the cathode may have a larger capacity or irreversible capacity than the anode, and that in such cases the layer comprising the source of electrode active material may compensate for the irreversible capacity of the cathode.

In some cases, an electrochemical cell also may comprise one or more additional optional components, such a containment structure and/or one or more current collectors, some of which are shown in FIG. 3D. FIG. 3D shows an electrochemical cell comprising optional containment structure 600, optional first electrode current collector 400, and optional second electrode current collector 500. While the first and second electrodes in FIG. 3A, FIG. 3B, FIG. 3C, and FIG. 3D are shown as having a planar configuration, other embodiments may include non-planar configurations. Additionally, non-planar arrangements, arrangements with proportions of materials different than those shown, and other alternative arrangements are useful in connection with certain embodiments. A typical electrochemical cell also could include, of course, external circuitry, housing structure, and the like. Those of ordinary skill in the art are well aware of the many arrangements that can be utilized with the general schematic arrangement as shown in the figures and described herein. According to certain embodiments, the first and second electrodes can be configured such that no intervening electrodes or portions of electrodes are positioned between the first electrode and the second electrode.

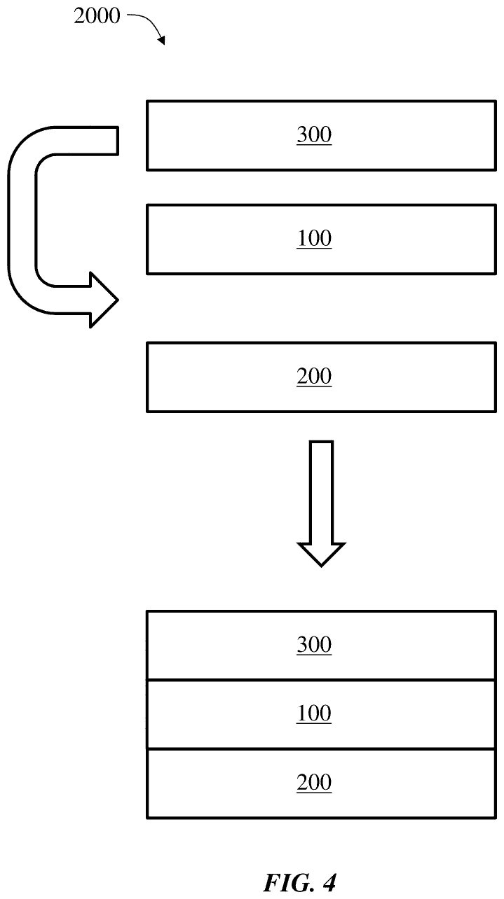

As described above, certain embodiments relate to methods for fabricating an electrochemical cell (e.g., an electrochemical cell such as those depicted in FIG. 3A, FIG. 3B, FIG. 3C, and FIG. 3D). For example, a method for fabricating an electrochemical cell may comprise a step of positioning a composite as described herein within an electrochemical cell (e.g., between a first electrode and a second electrode, optionally such that the layer comprising the lithium is positioned closer to the cathode than the anode). FIG. 4 shows one example of a method 2000 in which composite 100 is positioned between first electrode 200 and second electrode 300. It should be noted that while FIG. 4 shows the composite positioned such that it is in direct contact with both the first electrode and the second electrode, the composite may be positioned between the first electrode and the second electrode but not directly adjacent either or both of the first electrode and the second electrode. For example, the composite may be positioned such that one or more intervening cell components are present between the first electrode and the composite, or between the composite and the second electrode. In some embodiments, one of the intervening cell component(s) may be an electrolyte, such as a liquid, gel, or solid electrolyte. In some embodiments, one of the intervening cell component(s) may be a porous ceramic layer, such as a boehmite layer. The porous ceramic layer, if present, may be a coating on the composite positioned between the portion of the composite beneath the coating and the first electrode or between the portion of the composite beneath the coating and the second electrode.

According to certain embodiments, the composite may exist in a state, at some point in time, in which no electrodes are present. For example, in FIG. 1, composite 100 does not include any electrodes. In some embodiments, the first and/or second sides of the composite may be exposed to a gaseous environment, a non-electrode solid, and/or a liquid material. For example, in FIG. 1, each of external surfaces 113A and 113B are exposed to a gaseous environment. According to certain embodiments, the composite may be later integrated into an electrochemical cell, for example, as illustrated in FIG. 4.

In embodiments that relate to methods for fabricating an electrochemical cell, a composite as described herein may be added to the electrochemical cell at any point during cell construction. In some embodiments, the composite is added to the electrochemical cell as a component that comprises at least a separator and a layer comprising lithium (and/or sodium and/or magnesium). The composite may be the first or one of the first electrochemical cell components added to a housing, or may be the last or one of the last electrochemical cell components added to a housing. It may be added prior to at least one or both of the first electrode and the second electrode, or may be added after both the first electrode and the second electrode. In some embodiments, the composite may be added prior to the addition of an electrolyte (e.g., a liquid electrolyte) to the electrochemical cell. In some embodiments, the composite may be the second to last component added to the housing, and an electrolyte (e.g., a liquid electrolyte) may be added to the housing as the last component.

In some embodiments, a composite may serve as a substrate on which one or more electrochemical cell components are formed. As an example, a first or second electrode may be formed on a composite (e.g., on a layer comprising lithium and/or sodium and/or magnesium, on a surface of a separator opposite the layer comprising lithium and/or sodium and/or magnesium). In such embodiments, the composite may be a free-standing composite. In some embodiments, a first electrode may be formed on a first side of the composite, after which a second electrode may be formed on a second, opposite side of the composite. Optionally, this step may be followed by the deposition of a current collector onto the first and/or second electrode. The resultant stack can then be added, according to certain embodiments, to a housing.

Typically, the housing is sealed after all the components (e.g., first electrode, second electrode, composite, and any electrolyte) have been added. This may be accomplished by any suitable method known to one of ordinary skill in the art.

In some embodiments, the methods described herein that relate to electrochemical cell fabrication may have certain advantages in comparison to other cell fabrication methods lacking a composite as described herein. For instance, it may be beneficial to use the composite (e.g., by adding the composite to a housing, by forming a first and/or second electrode over the composite, etc.) as a material that comprises both a separator and a layer comprising lithium (and/or sodium and/or magnesium). As an example, it may be easier and/or less expensive to handle a layer comprising lithium (and/or sodium and/or magnesium) as part of a composite than to deposit the layer comprising lithium (and/or sodium and/or magnesium) onto one or more cell components after they have been assembled. In some cases, the composite may be added to the cell under milder conditions than layers comprising lithium (and/or sodium and/or magnesium) are typically added to cells. For example, the composite may be added to the electrochemical cell in a dry room instead of under an inert atmosphere. As another example, certain cell components may be unsuitable for lithium (and/or sodium and/or magnesium) deposition for a variety of reasons, including but not limited to being incompatible with the temperatures and/or vacuums typically employed during lithium (and/or sodium and/or magnesium) layer formation and/or comprising one or more materials that may undergo an undesirable reaction with lithium vapor (and/or sodium vapor and/or magnesium vapor). In certain embodiments, the layer comprising lithium (and/or sodium and/or magnesium) of the composite may be passivated, which may reduce or eliminate the need for high vacuum or inert conditions during electrochemical cell fabrication that may be necessary for other means of introducing lithium into the electrochemical cell. These conditions may require expensive equipment, be expensive to operate, and/or be challenging or impossible to integrate with continuous manufacturing techniques.

As described above, certain embodiments are related to electrochemical cell components that are composites comprising a layer comprising lithium (and/or sodium and/or magnesium) disposed on the surface of a separator. In such embodiments, the strength of adhesion between the layer comprising the lithium (and/or sodium and/or magnesium) and the separator may relatively high (e.g., large enough that layer comprising the lithium and/or the sodium and/or the magnesium remains attached to the separator during normal cell and/or separator fabrication and/or handling). In other words, the layer comprising the lithium may be adhered to the separator. The adhesion can be achieved, according to certain embodiments, by depositing the layer comprising the lithium (and/or sodium and/or magnesium) on a surface of the separator, or by any other suitable method. In some embodiments, the strength of adhesion between the layer comprising the lithium (and/or the sodium and/or the magnesium) and the separator is at least 0.2 MPa, at least 0.4 MPa, or at least 0.6 MPa. In some embodiments, the strength of adhesion between the layer comprising the lithium (and/or the sodium and/or the magnesium) and the separator is less than or equal to 0.8 MPa, less than or equal to 0.6 MPa, or less than or equal to 0.4 MPa. Combinations of the above-referenced ranges are also possible (e.g., at least 0.2 MPa and less than or equal to 0.8 MPa). Other ranges are also possible. The strength of adhesion between the layer comprising the lithium (and/or the sodium and/or the magnesium) may be determined by ASTM D4541. Briefly, a 20 mm dolly may be fixed to the layer comprising the lithium (and/or the sodium and/or the magnesium) with an adhesive. A force normal to the surface of the layer comprising the lithium (and/or the sodium and/or the magnesium) is then applied to the dolly and increased at a rate of 1 MPa per second until the dolly and the layer comprising the lithium (and/or the sodium and/or the magnesium) detach from the separator. At the conclusion of the test, the following equation can be used to determine the strength of adhesion:

$$X = \frac{4 F}{π {d}^{2}} ,$$

where X is equal to the force applied to the dolly when the dolly and the layer comprising the lithium (and/or the sodium and/or the magnesium) detach from the separator, F is the strength of adhesion between the layer comprising the lithium (and/or the sodium and/or the magnesium) and the separator, and d is the diameter of the dolly.

In some embodiments, a strength of adhesion between a layer comprising lithium (and/or sodium and/or magnesium) and a separator may be high enough such that a composite comprising the layer comprising lithium disposed on the separator may achieve a score of at least 3 A, at least 4 A, or equal to 5 A on a tape test performed in accordance with Test Method A described in ASTM D3359. Briefly, this test may be performed by making an X-cut through the entirety of the thickness of the layer comprising the lithium (and/or the sodium and/or the magnesium), applying pres sure-sensitive tape over the X-cut, and then rapidly removing the pressure-sensitive tape by peeling it back at angle as close as possible to 180°. The amount and quality of delamination of the layer comprising lithium (and/or sodium and/or magnesium) at the conclusion of the tape test may be assigned a score from 0 A to 5 A. A score of 3 A indicates jagged removal of the layer comprising the lithium (and/or the sodium and/or the magnesium) up to 1.6 mm on either side of the X-cut; a score of 4 A indicates trace peeling or removal of the comprising lithium (and/or sodium and/or magnesium) along the X-cut; a score of 5 A indicates no peeling or removal of the layer comprising lithium (and/or sodium and/or magnesium).

In some embodiments, a composite may comprise a layer comprising lithium (and/or sodium and/or magnesium) disposed on the surface of a separator, and the layer comprising the lithium (and/or sodium and/or magnesium) may not intermix significantly with the separator and/or may not penetrate significantly into the body of the separator. In some embodiments, the layer comprising the lithium (and/or the sodium and/or the magnesium) may not extend through more than 20% of the thickness of the separator, may not extend through more than 15% of the thickness of the separator, may not extend through more than 10% of the thickness of the separator, or may not extend through more than 7.5% through the thickness of the separator. In some embodiments, the layer comprising the lithium (and/or the sodium and/or the magnesium) may extend through at least 4% of the thickness of the separator, may extend through at least 7.5% of the thickness of the separator, may extend through at least 10% of the thickness of the separator, or may extend through at least 15% of the thickness of the separator. Combinations of the above-referenced ranges are also possible (e.g., the layer comprising the lithium and/or the sodium and/or the magnesium may not extend through more than 20% of the thickness of the separator and may extend through at least 4% of the thickness of the separator). Other ranges are also possible. The extent of penetration of the layer comprising the lithium (and/or sodium and/or magnesium) into the separator may be determined by SEM imaging.

In some embodiments, a composite may comprise a layer comprising lithium disposed on the surface of a separator, and lithium may make up less than or equal to 10% of the solid volume within the geometric volume of the separator, less than or equal to 7.5% of the solid volume within the geometric volume of the separator, or less than or equal to 5% of the solid volume within the geometric volume of the separator. In some embodiments, lithium may make up greater than or equal to 3% of the solid volume within the geometric volume of the separator, greater than or equal to 5% of the solid volume within the geometric volume of the separator, or greater than or equal to 7.5% of the solid volume within the geometric volume of the separator. Combinations of the above-referenced ranges are also possible (e.g., less than or equal to 10% of the solid volume within the geometric volume of the separator and greater than or equal to 3% of the solid volume within the geometric volume of the separator). The percentage of the geometric volume of the separator occupied by solid lithium (% GV_{Li}) is determined as follows:

$$\% {GV}_{L i} = \frac{S {V}_{L i}}{G {V}_{s e p}} \times 100 \%$$

wherein SV_{Li} is the solid volume of lithium within the geometric volume of the separator, and GVₛₑₚ is the geometric volume of the separator. The solid volume of lithium within the geometric volume of the separator (SV_{Li}) is determined by measuring the pore volume of the separator prior to removal of the lithium, removing the lithium from the pores of the separator, and then re-measuring the pore volume of the separator after removing the lithium. The solid volume of lithium within the geometric volume of the separator (SV_{Li}) is then calculated by subtracting the pore volume of the separator prior to lithium removal from the pore volume of the separator after lithium removal.

In some embodiments, a composite may comprise a layer comprising sodium disposed on the surface of a separator, and sodium may make up less than or equal to 10% of the solid volume within the geometric volume of the separator, less than or equal to 7.5% of the solid volume within the geometric volume of the separator, or less than or equal to 5% of the solid volume within the geometric volume of the separator. In some embodiments, sodium may make up greater than or equal to 3% of the solid volume within the geometric volume of the separator, greater than or equal to 5% of the solid volume within the geometric volume of the separator, or greater than or equal to 7.5% of the solid volume within the geometric volume of the separator. Combinations of the above-referenced ranges are also possible (e.g., less than or equal to 10% of the solid volume within the geometric volume of the separator and greater than or equal to 3% of the solid volume within the geometric volume of the separator). The percentage of the geometric volume of the separator occupied by solid sodium (% GV_{Na}) is determined as follows:

$$\% {GV}_{N a} = \frac{S {V}_{N a}}{G {V}_{s e p}} \times 100 \%$$

wherein SV_{Na} is the solid volume of sodium within the geometric volume of the separator, and GVₛₑₚ is the geometric volume of the separator. The solid volume of sodium within the geometric volume of the separator (SV_{Na}) is determined by measuring the pore volume of the separator prior to removal of the sodium, removing the sodium from the pores of the separator, and then re-measuring the pore volume of the separator after removing the sodium. The solid volume of sodium within the geometric volume of the separator (SV_{Na}) is then calculated by subtracting the pore volume of the separator prior to sodium removal from the pore volume of the separator after sodium removal.

In some embodiments, a composite may comprise a layer comprising magnesium disposed on the surface of a separator, and magnesium may make up less than or equal to 10% of the solid volume within the geometric volume of the separator, less than or equal to 7.5% of the solid volume within the geometric volume of the separator, or less than or equal to 5% of the solid volume within the geometric volume of the separator. In some embodiments, magnesium may make up greater than or equal to 3% of the solid volume within the geometric volume of the separator, greater than or equal to 5% of the solid volume within the geometric volume of the separator, or greater than or equal to 7.5% of the solid volume within the geometric volume of the separator. Combinations of the above-referenced ranges are also possible (e.g., less than or equal to 10% of the solid volume within the geometric volume of the separator and greater than or equal to 3% of the solid volume within the geometric volume of the separator). The percentage of the geometric volume of the separator occupied by solid magnesium (% GV_{Mg}) is determined as follows:

$$\% {GV}_{M g} = \frac{S {V}_{M g}}{G {V}_{s e p}} \times 100 \%$$

wherein SV_{Mg} is the solid volume of magnesium within the geometric volume of the separator, and GVₛₑₚ is the geometric volume of the separator. The solid volume of magnesium within the geometric volume of the separator (SV_{Mg}) is determined by measuring the pore volume of the separator prior to removal of the magnesium, removing the magnesium from the pores of the separator, and then re-measuring the pore volume of the separator after removing the magnesium. The solid volume of magnesium within the geometric volume of the separator (SV_{Mg}) is then calculated by subtracting the pore volume of the separator prior to magnesium removal from the pore volume of the separator after magnesium removal.

In some embodiments, a composite may comprise a layer comprising lithium (and/or sodium and/or magnesium) disposed on the surface of a separator, and one or more polymers may make up greater than or equal to 20% of the solid volume within the geometric volume of the separator, greater than or equal to 50% of the solid volume within the geometric volume of the separator, greater than or equal to 75% of the solid volume within the geometric volume of the separator, greater than or equal to 90% of the solid volume within the geometric volume of the separator, greater than or equal to 92.5% of the solid volume within the geometric volume of the separator, or greater than or equal to 95% of the solid volume within the geometric volume of the separator. In some embodiments, one or more polymer may make up less than or equal to 97% of the solid volume within the geometric volume of the separator, less than or equal to 95% of the solid volume within the geometric volume of the separator, less than or equal to 92.5% of the solid volume within the geometric volume of the separator, less than or equal to 90% of the solid volume within the geometric volume of the separator, less than or equal to 75% of the solid volume within the geometric volume of the separator, or less than or equal to 50% of the solid volume within the geometric volume of the separator. Combinations of the above-referenced ranges are also possible (e.g., greater than or equal to 20% of the solid volume within the geometric volume of the separator and less than or equal to 97% of the solid volume within the geometric volume of the separator, or greater than or equal to 20% of the solid volume within the geometric volume of the separator and less than or equal to 90% of the solid volume within the geometric volume of the separator). Other ranges are also possible. The percentage of solid volume within the geometric volume of the separator occupied by one or more polymers may be determined by dividing the solid volume occupied by one or more polymers within the geometric volume of the separator by the solid volume of the separator and multiplying by 100%.

The solid volume occupied by one or more polymers within the geometric volume of the separator may be determined by compositional analysis using a TGA protocol as described in ASTM E1131-08. Briefly, a sample of the composite may be subject to TGA analysis to determine its composition. The TGA analysis is performed by heating the sample at a rate of 10° C. per minute under an inert gas flow rate of 50 mL per minute and monitoring the weight loss of the sample over time. Each component of the composite typically has a known temperature at which it decomposes (either known a priori or determined by heating a pure sample of the component under the conditions described above and observing the decomposition temperature), and so the weight fraction of the polymer within the separator may be determined by dividing the mass loss at the decomposition temperature for the polymer by the total mass of the sample of separator. The volume fraction of the polymer may then be determined by dividing the weight fraction of the polymer by the density of the polymer.

In some embodiments, a composite may comprise a layer comprising lithium (and/or sodium and/or magnesium) disposed on the surface of a separator, and the composite may have a permeability of faster than or equal to 45,000 Gurley-seconds, faster than or equal to 30,000 Gurley-seconds, faster than or equal to 15,000 Gurley-seconds, faster than or equal to 5,000 Gurley-seconds, faster than or equal to 500 Gurley-seconds, or faster than or equal to 100 Gurley-seconds. In some embodiments, the composite may have a permeability of slower than or equal to 0 Gurley-seconds, slower than or equal to 100 Gurley-seconds, slower than or equal to 500 Gurley-seconds, slower than or equal to 5,000 Gurley-seconds, slower than or equal to 15,000 Gurley-seconds, or slower than or equal to 30,000 Gurley-seconds. Combinations of the above-referenced ranges are also possible (e.g., faster than or equal to 45,000 Gurley-seconds and slower than or equal to 0 Gurley-seconds). Other ranges are also possible. The permeability of a layer may be measured by the Gurley Test. The Gurley Test determines the time required for a specific volume of air to flow through a standard area of the material. As such, larger air permeation times (Gurley seconds) generally correspond to better barrier properties. The air permeation times and Gurley tests described herein refer to those performed according to TAPPI Standard T 536 om-12, which involves a pressure differential of 3 kPa and a sample size of one square inch.

In embodiments in which a composite comprising a layer comprising lithium (and/or sodium and/or magnesium) is provided, the layer comprising the lithium (and/or sodium and/or magnesium) may have any suitable thickness. In some embodiments, the layer comprising the lithium (and/or sodium and/or magnesium) may have a thickness of greater than or equal to 0.5 microns, greater than or equal to 0.75 microns, greater than or equal to 1 micron, greater than or equal to 2 microns, greater than or equal to 3 microns, or greater than or equal to 4 microns. In some embodiments, the layer comprising the lithium (and/or sodium and/or magnesium) may have a thickness of less than or equal to 5 microns, less than or equal to 4 microns, less than or equal to 3 microns, less than or equal to 2 microns, less than or equal to 1 micron, or less than or equal to 0.75 microns. Combinations of the above-referenced ranges are also possible (e.g., greater than or equal to 0.5 microns and less than or equal to 5 microns). Other ranges are also possible. The thickness of the layer comprising the lithium (and/or sodium and/or magnesium) may be measured by a drop gauge.

In some embodiments in which a composite comprising a layer comprising lithium is provided, the layer comprising lithium may contain a relatively high amount of lithium. In some embodiments which a composite comprising a layer comprising lithium is provided, the layer comprising lithium may comprise lithium in an amount of at least 50 wt %, at least 75 wt %, at least 90 wt %, at least 95 wt %, at least 97 wt %, at least 99 wt %, at least 99.5 wt %, or at least 99.9 wt %. In some embodiments which a composite comprising a layer comprising lithium is provided, the layer comprising lithium may comprise lithium in an amount of at most 100 wt %, at most 99.9 wt %, at most 99.5 wt %, at most 99 wt %, at most 97 wt %, at most 95 wt %, at most 90 wt %, or at most 75 wt %. Combinations of the above-referenced ranges are also possible (e.g., at least 50 wt % and at most 100 wt %). Other ranges are also possible. In some embodiments, the layer comprising the lithium may be a single material layer as described above. In some embodiments in which a composite comprising a layer comprising lithium is provided, the layer comprising the lithium may comprise lithium metal. The lithium metal may be a lithium metal that has been deposited by a vacuum deposition technique, such as sputtering, thermal evaporation, electron beam deposition, and the like. In some embodiments, the lithium metal may be in the form of a lithium foil. In some embodiments, the layer comprising the lithium may comprise a lithium alloy (e.g., an alloy of lithium with one or more of aluminum, magnesium, silicium, silicon, indium, and tin). In some embodiments, the layer comprising the lithium is a lithium metal layer containing a relatively high amount of lithium. For instance, in some embodiments, the layer comprising the lithium may be a lithium metal layer containing at least 95 wt % lithium, containing at least 97 wt % lithium, containing at least 99 wt % lithium, containing at least 99.5 wt % lithium, or containing at least 99.9 wt % lithium. In some embodiments, the layer comprising the lithium may be a single phase material, such as a single phase lithium metal or a single phase lithium alloy.

In some embodiments in which a composite comprising a layer comprising sodium is provided, the layer comprising sodium may contain a relatively high amount of sodium. In some embodiments which a composite comprising a layer comprising sodium is provided, the layer comprising sodium may comprise sodium in an amount of at least 50 wt %, at least 75 wt %, at least 90 wt %, at least 95 wt %, at least 97 wt %, at least 99 wt %, at least 99.5 wt %, or at least 99.9 wt %. In some embodiments which a composite comprising a layer comprising sodium is provided, the layer comprising sodium may comprise sodium in an amount of at most 100 wt %, at most 99.9 wt %, at most 99.5 wt %, at most 99 wt %, at most 97 wt %, at most 95 wt %, at most 90 wt %, or at most 75 wt %. Combinations of the above-referenced ranges are also possible (e.g., at least 50 wt % and at most 100 wt %). Other ranges are also possible. In some embodiments, the layer comprising the sodium may be a single material layer as described above. In some embodiments in which a composite comprising a layer comprising sodium is provided, the layer comprising the sodium may comprise sodium metal. The sodium metal may be a sodium metal that has been deposited by a vacuum deposition technique, such as sputtering, thermal evaporation, electron beam deposition, and the like. In some embodiments, the sodium metal may be in the form of a sodium foil. In some embodiments, the layer comprising the sodium may comprise a sodium alloy (e.g., an alloy of sodium with one or more of aluminum, magnesium, silicium, silicon, indium, and tin). In some embodiments, the layer comprising the sodium is a sodium metal layer containing a relatively high amount of sodium. For instance, in some embodiments, the layer comprising the sodium may be a sodium metal layer containing at least 95 wt % sodium, containing at least 97 wt % sodium, containing at least 99 wt % sodium, containing at least 99.5 wt % sodium, or containing at least 99.9 wt % sodium. In some embodiments, the layer comprising the sodium may be a single phase material, such as a single phase sodium metal or a single phase sodium alloy.

In some embodiments in which a composite comprising a layer comprising magnesium is provided, the layer comprising magnesium may contain a relatively high amount of magnesium. In some embodiments which a composite comprising a layer comprising magnesium is provided, the layer comprising magnesium may comprise magnesium in an amount of at least 50 wt %, at least 75 wt %, at least 90 wt %, at least 95 wt %, at least 97 wt %, at least 99 wt %, at least 99.5 wt %, or at least 99.9 wt %. In some embodiments which a composite comprising a layer comprising magnesium is provided, the layer comprising magnesium may comprise magnesium in an amount of at most 100 wt %, at most 99.9 wt %, at most 99.5 wt %, at most 99 wt %, at most 97 wt %, at most 95 wt %, at most 90 wt %, or at most 75 wt %. Combinations of the above-referenced ranges are also possible (e.g., at least 50 wt % and at most 100 wt %). Other ranges are also possible. In some embodiments, the layer comprising the magnesium may be a single material layer as described above.

In some embodiments in which a composite comprising a layer comprising magnesium is provided, the layer comprising the magnesium may comprise magnesium metal. The magnesium metal may be a magnesium metal that has been deposited by a vacuum deposition technique, such as sputtering, thermal evaporation, electron beam deposition, and the like. In some embodiments, the magnesium metal may be in the form of a magnesium foil. In some embodiments, the layer comprising the magnesium may comprise a magnesium alloy (e.g., an alloy of magnesium with one or more of aluminum, lithium, silicium, silicon, indium, and tin). In some embodiments, the layer comprising the magnesium is a magnesium metal layer containing a relatively high amount of magnesium. For instance, in some embodiments, the layer comprising the magnesium may be a magnesium metal layer containing at least 95 wt % magnesium, containing at least 97 wt % magnesium, containing at least 99 wt % magnesium, containing at least 99.5 wt % magnesium, or containing at least 99.9 wt % magnesium. In some embodiments, the layer comprising the magnesium may be a single phase material, such as a single phase magnesium metal or a single phase magnesium alloy.

In some embodiments in which a composite comprising a layer comprising lithium (and/or sodium and/or magnesium) is provided, the layer comprising the lithium (and/or sodium and/or magnesium) may further comprise one or more components that are not lithium, a lithium alloy, sodium, a sodium alloy, magnesium, or a magnesium alloy. In some embodiments, such components may make up a relatively low percentage of the layer comprising lithium (and/or sodium and/or magnesium). For instance, in some embodiments the layer comprising the lithium (and/or sodium and/or magnesium) may comprise binder in a relatively small amount. In some embodiments, binder may make up less than or equal to 20 wt % of the layer comprising the lithium (and/or sodium and/or magnesium), less than or equal to 10 wt % of the layer comprising the lithium (and/or sodium and/or magnesium), less than or equal to 5 wt % of the layer comprising the lithium (and/or sodium and/or magnesium), less than or equal to 2 wt % of the layer comprising the lithium (and/or sodium and/or magnesium), less than or equal to 1 wt % of the layer comprising the lithium (and/or sodium and/or magnesium), or less than or equal to 0.1 wt % of the layer comprising the lithium (and/or sodium and/or magnesium). In some embodiments, binder may make up greater than or equal to 0 wt % of the layer comprising the lithium (and/or sodium and/or magnesium), greater than or equal to 0.1 wt % of the layer comprising the lithium (and/or sodium and/or magnesium), greater than or equal to 1 wt % of the layer comprising the lithium (and/or sodium and/or magnesium), greater than or equal to 2 wt % of the layer comprising the lithium (and/or sodium and/or magnesium), greater than or equal to 5 wt % of the layer comprising the lithium (and/or sodium and/or magnesium), or greater than or equal to 10 wt % of the layer comprising the lithium (and/or sodium and/or magnesium). Combinations of the above-referenced ranges are also possible (e.g., less than or equal to 20 wt % and greater than or equal to 0 wt % of the layer comprising the lithium (and/or sodium and/or magnesium)). Other ranges are also possible. In this context, “binder” refers to material that is not an electrode active material and is not included to provide an electrically conductive pathway for the electrode. For example, an electrode might contain binder to facilitate internal cohesion within the cathode.

In some embodiments the layer comprising the lithium (and/or sodium and/or magnesium) may comprise binder in a relatively large amount. In some embodiments, binder may make up greater than or equal to 50 wt % of the layer comprising the lithium (and/or sodium and/or magnesium), greater than or equal to 75 wt % of the layer comprising the lithium (and/or sodium and/or magnesium), greater than or equal to 80 wt % of the layer comprising the lithium (and/or sodium and/or magnesium), greater than or equal to 90 wt % of the layer comprising the lithium (and/or sodium and/or magnesium), greater than or equal to 95 wt % of the layer comprising the lithium (and/or sodium and/or magnesium), or greater than or equal to 98 wt % of the layer comprising the lithium (and/or sodium and/or magnesium). In some embodiments, binder may make up less than or equal to 99 wt % of the layer comprising the lithium (and/or sodium and/or magnesium), less than or equal to 98 wt % of the layer comprising the lithium (and/or sodium and/or magnesium), less than or equal to 95 wt % of the layer comprising the lithium (and/or sodium and/or magnesium), less than or equal to 90 wt % of the layer comprising the lithium (and/or sodium and/or magnesium), less than or equal to 80 wt % of the layer comprising the lithium (and/or sodium and/or magnesium), or less than or equal to 75 wt % of the layer comprising the lithium (and/or sodium and/or magnesium). Combinations of the above-referenced ranges are also possible (e.g., greater than or equal to 50 wt % and greater than or equal to 99 wt % of the layer comprising the lithium (and/or sodium and/or magnesium)). Other ranges are also possible.

In some embodiments in which a composite comprising a layer comprising lithium (and/or sodium and/or magnesium) is provided, one or more components of the layer comprising the lithium (and/or sodium and/or magnesium) (e.g., lithium metal, a lithium alloy, sodium metal, a sodium alloy, magnesium metal, a magnesium alloy) may be in the form of particles. As used herein, a particle is a solid that has a volume of less than or equal to 200 microns. In some embodiments, particles may make up a relatively low amount of the overall weight of the layer comprising the lithium (and/or sodium and/or magnesium). For instance, particles may make up less than or equal to 40 wt % of the layer comprising the lithium (and/or sodium and/or magnesium), less than or equal to 30 wt % of the layer comprising the lithium (and/or sodium and/or magnesium), less than or equal to 20 wt % of the layer comprising the lithium (and/or sodium and/or magnesium), less than or equal to 10 wt % of the layer comprising the lithium (and/or sodium and/or magnesium), less than or equal to 5 wt % of the layer comprising the lithium (and/or sodium and/or magnesium), less than or equal to 2 wt % of the layer comprising the lithium (and/or sodium and/or magnesium), less than or equal to 1 wt % of the layer comprising the lithium (and/or sodium and/or magnesium), or less than or equal to 0.1 wt % of the layer comprising the lithium (and/or sodium and/or magnesium).

In some embodiments, the particles may make up greater than or equal to 0 wt % of the layer comprising the lithium (and/or sodium and/or magnesium), greater than or equal to 0.1 wt % of the layer comprising the lithium (and/or sodium and/or magnesium), greater than or equal to 1 wt % of the layer comprising the lithium (and/or sodium and/or magnesium), greater than or equal to 2 wt % of the layer comprising the lithium (and/or sodium and/or magnesium), greater than or equal to 5 wt % of the layer comprising the lithium (and/or sodium and/or magnesium), greater than or equal to 10 wt % of the layer comprising the lithium (and/or sodium and/or magnesium), greater than or equal to 20 wt % of the layer comprising the lithium (and/or sodium and/or magnesium), or greater than or equal to 30 wt % of the layer comprising the lithium (and/or sodium and/or magnesium). Combinations of the above-referenced ranges are also possible (e.g., less than or equal to 40 wt % and greater than or equal to 0 wt % of the layer comprising the lithium (and/or sodium and/or magnesium)). Other ranges are also possible.

In some embodiments in which a composite comprising a layer comprising lithium (and/or sodium and/or magnesium) is provided, a surface of the layer comprising the lithium (and/or sodium and/or magnesium) may be passivated. For example, a surface of the layer comprising the lithium (and/or sodium and/or magnesium) furthest from a separator on which it is disposed may be passivated In some embodiments, more than one surface of the layer comprising the lithium (and/or sodium and/or magnesium) may be passivated, or all external surfaces of the layer comprising the lithium (and/or sodium and/or magnesium) may be passivated. Surfaces of the layer comprising the lithium (and/or sodium and/or magnesium) that are passivated are surfaces of the layer comprising the lithium (and/or sodium and/or magnesium) that have undergone a chemical reaction to form a layer that is less reactive (e.g., with an ambient atmosphere, with a fluid, with a solvent with an electrolyte) than material that is present in the bulk of the layer comprising the lithium. One method of passivating a surface of the layer comprising the lithium (and/or sodium and/or magnesium) is to expose the layer comprising the lithium (and/or sodium and/or magnesium) to a plasma comprising CO₂ and/or SO₂ to form a CO₂- or SO₂-induced layer. Certain inventive methods and articles may comprise passivating the layer comprising the lithium (and/or sodium and/or magnesium) by exposing it to CO₂ and/or SO₂, or may comprise a layer comprising lithium (and/or sodium and/or magnesium) with a surface that has been passivated by exposure to CO₂ and/or SO₂. Such exposure may form a porous passivation layer on the layer comprising the lithium (and/or sodium and/or magnesium) (e.g., a CO₂- or SO₂-induced layer). In some cases, a passivation layer (e.g., a layer formed by reaction between the layer comprising the lithium and/or sodium and/or magnesium with CO₂ and/or SO₂) may be observed on a surface of the layer comprising the lithium (and/or sodium and/or magnesium) by scanning electron microscopy.

In some embodiments, passivating the surface of the layer comprising the lithium (and/or sodium and/or magnesium) may be advantageous because it may allow for the composite to be handled safely and under conditions where lithium (and/or sodium and/or magnesium) that has not been passivated would be reactive. In some cases, the layer comprising the lithium (and/or sodium and/or magnesium) may be sufficiently passivated so that the composite can be wound and unwound (e.g., during roll to roll coating) without sticking together. For example, the composite may be capable of being wound and unwound without significant delamination occurring between the separator and the layer comprising the lithium (and/or sodium and/or magnesium). In some cases, the composite may be capable of being wound and unwound such that less than or equal to 5%, less than or equal to 3%, or less than or equal to 1% of area of the layer comprising the lithium (and/or sodium and/or magnesium) is delaminated from the rest of the composite (e.g., from the separator). As used herein, “winding” the composite constitutes rolling the composite from a substantially flat state until at least a portion of the back side of the composite contacts at least a portion of the front side of the composite, and “unwinding” the composite constitutes returning the composite to a substantially flat state. In some such embodiments, “winding” the composite comprises forming a smallest radius of curvature that is less than 5 cm, less than 2 cm, less than 1 cm, or less than 0.5 cm. The percentage of the area of the layer comprising the lithium (and/or sodium and/or magnesium) that is delaminated from the rest of the composite may be determined by visual inspection.

In some embodiments in which a composite comprising a layer comprising lithium (and/or sodium and/or magnesium) with a passivated surface is provided, the passivated surface may be in the form of a passivation layer (i.e., the layer comprising the lithium and/or sodium and/or magnesium may further comprise a passivation layer). The thickness of the passivation layer may be any suitable value. In some embodiments, the passivation layer may have a thickness of less than or equal to 500 nm, less than or equal to 100 nm, less than or equal to 50 nm, less than or equal to 20 nm, less than or equal to 10 nm, less than or equal to 5 nm, less than or equal to 2 nm, or less than or equal to 1 nm. In some embodiments, the passivation layer may have a thickness of greater than or equal to 0.5 nm, greater than or equal to 1 nm, greater than or equal to 2 nm, greater than or equal to 5 nm, greater than or equal to 10 nm, greater than or equal to 20 nm, greater than or equal to 50 nm, or greater than or equal to 100 nm. Combinations of the above-referenced ranges are also possible (e.g., less than or equal to 500 nm and greater than or equal to 0.5 nm). Other ranges are also possible. The thickness of the passivation layer may be determined by scanning electron microscopy.

As described above, certain embodiments relate to composites that comprise a separator. In some embodiments, the separator may be electronically insulating, or may have an electronic conductivity low enough that transport of electrons through its bulk is strongly hindered. This forces the majority (or all) of the electrons to be transferred between the first electrode and the second electrode via an external load (when discharging) or via the charging mechanism (when charging). In certain embodiments, the separator may have an electronic conductivity of 10⁻⁵ S/cm, less than or equal to 10⁻⁶ S/cm, less than or equal to 10⁻⁷ S/cm, less than or equal to 10⁻⁸ S/cm, less than or equal to 10 S/cm, less than or equal to 10⁻¹⁰ S/cm, less than or equal to 10⁻¹¹ S/cm, less than or equal to 10⁻¹² S/cm, less than or equal to 10⁻¹³ S/cm, or less than or equal to 10⁻¹⁴ S/cm. In certain embodiments, the separator may have an electronic conductivity of greater than or equal to 10⁻¹⁵ S/cm, greater than or equal to 10⁻¹⁴ S/cm, greater than or equal to 10⁻¹³ S/cm, greater than or equal to 10⁻¹² S/cm, greater than or equal to 10⁻¹¹ S/cm, greater than or equal to 10⁻¹⁰ S/cm, greater than or equal to 10 S/cm, greater than or equal to 10⁻⁸ S/cm, or greater than or equal to 10⁻⁶ S/cm. Combinations of the above-referenced ranges are also possible (e.g., greater than or equal to 10⁻¹⁵ S/cm and less than or equal to 10⁻⁷ S/cm). Other ranges are also possible.

The electronic conductivity of a separator is measured by electrochemical impedance spectroscopy (EIS), and is measured in a direction corresponding to the direction through which ions are transported through the separator during operation of the electrochemical cell. Generally, electrochemical impedance spectroscopy conductivity measurements are made by assembling a cell in which the component that is being measured (such as, e.g., the separator) is positioned between two electronically conductive substrates. The complex impedance across the cell component (which has known dimensions) is determined by passing a 5 mV alternating voltage across the electronically conductive substrates at a 0 V bias and measuring the real and imaginary impedance between the electronically conductive substrates as a function of frequency between 100 kHz and 20 mHz. Components which have both electrical and ionic conductivity will typically display a low frequency relaxation arising from electronic conductivity and a high frequency relaxation arising from both electronic and ionic conductivity. The low frequency relaxation may be used to determine the electrical resistance of the cell component, from which the electrical conductivity can be calculated based on the geometry of the cell component. The high frequency relaxation may then be used to determine the ionic conductivity of the cell component by assuming that the ionic resistance of the component and the electronic resistance of the component act in parallel and then calculating the ionic resistance that would give rise to the measured high frequency relaxation. The ionic conductivity may then be determined based on geometry of the cell component. In this context, the geometry across which the electronic conductivity is measured is calculated using the geometric surfaces of the cell component. The geometric surfaces of a cell component would be understood by those of ordinary skill in the art as referring to the surfaces defining the outer boundaries of the cell component, for example, the area that may be measured by a macroscopic measuring tool (e.g., a ruler), and do not include the internal surface area (e.g., area within pores of a porous material such as a porous membrane separator, etc.).

In some embodiments, a composite may comprise a separator with relatively high ionic conductivity. In certain embodiments, the separator may have an ionic conductivity of greater than or equal to 10⁻⁷ S/cm, greater than or equal to 10⁻⁶ S/cm, greater than or equal to 10⁻⁵ S/cm, greater than or equal to 10⁻⁴ S/cm, greater than or equal to 10⁻³ S/cm, greater than or equal to 10⁻² S/cm, greater than or equal to 10⁻¹ S/cm, greater than or equal to 1 S/cm, or greater than or equal to 10 S/cm. In certain embodiments, the separator may have an ionic conductivity of less than or equal to 100 S/cm, less than or equal to 10 S/cm, less than or equal to 1 S/cm, less than or equal to 10⁻¹ S/cm, less than or equal to 10⁻² S/cm, less than or equal to 10⁻³ S/cm, less than or equal to 10⁻⁴ S/cm, less than or equal to 10⁻⁵ S/cm, or less than or equal to 10⁻⁶ S/cm. Combinations of the above-referenced ranges are also possible (e.g., greater than or equal to 10⁻⁴ S/cm and less than or equal to 100 S/cm). Other ranges are also possible. The ionic conductivity of the separator may be determined using electrochemical impedance spectroscopy as described above.

According to certain embodiments, a composite may comprise a separator with relatively high electrolyte permeability (i.e., the permeability of the liquid component of the electrolyte). The electrolyte permeability of the separator may be measured by the Gurley Test as described above. In certain embodiments, the separator has an electrolyte permeability of greater than or equal to 10 Gurley seconds, greater than or equal to 20 Gurley seconds, greater than or equal to 50 Gurley seconds, greater than or equal to 100 Gurley seconds, greater than or equal to 200 Gurley seconds, or greater than or equal to 500 Gurley seconds. In certain embodiments, the separator has an electrolyte permeability of less than or equal to 1000 Gurley seconds, less than or equal to 500 Gurley seconds, less than or equal to 250 Gurley seconds, less than or equal to 100 Gurley seconds, less than or equal to 50 Gurley seconds, or less than or equal to 20 Gurley seconds. Combinations of the above-referenced ranges are also possible (e.g., greater than or equal to 50 Gurley seconds and less than or equal to 1000 Gurley seconds). Other ranges are also possible.

In some embodiments, the electrochemical cell may comprise a separator, and the separator may comprise pores. For example, the separator may be a porous polymeric membrane. The separator may comprise pores with a size distribution chosen to enhance the performance of the electrochemical cell. In some cases, the pores may be smaller than millimeter-scale pores, which may be so large that they render the layer mechanically unstable. In some embodiments, it may be advantageous to use a separator where the pores have cross-sectional diameters within a designated range. For example, in some cases, the separator may comprise pores wherein at least 50% of the pore volume, at least 75% of the pore volume, or at least 90% of the pore volume is made up of pores with a cross-sectional diameter of greater than or equal to 0.001 microns, greater than or equal to 0.002 microns, greater than or equal to 0.005 microns, greater than or equal to 0.01 microns, greater than or equal to 0.02 microns, greater than or equal to 0.05 microns, greater than or equal to 0.1 microns, or greater than or equal to 0.2 microns. In some cases, the separator may comprise pores wherein at least 50% of the pore volume, at least 75% of the pore volume, or at least 90% of the pore volume is made up of pores with a cross-sectional diameter of less than or equal to 0.5 microns, less than or equal to 0.2 microns, less than or equal to 0.1 microns, less than or equal to 0.05 microns, less than or equal to 0.02 microns, less than or equal to 0.01 microns, less than or equal to 0.005 microns, or less than or equal to 0.002 microns. Combinations of the above-referenced ranges are also possible (e.g., greater than or equal to 0.001 microns and less than or equal to 0.5 microns). Other ranges are also possible.

As used herein, the “cross-sectional diameter” of a pore refers to a cross-sectional diameter as measured using ASTM Standard Test D4284-07. One of ordinary skill in the art would be capable of calculating the distribution of cross-sectional diameters and the average cross-sectional diameter of the pores within a layer using mercury intrusion porosimetry as described in ASTM standard D4284-07, which is incorporated herein by reference in its entirety. For example, the methods described in ASTM standard D4284-07 can be used to produce a distribution of pore sizes plotted as the cumulative intruded pore volume as a function of pore diameter. To calculate the fraction of the total pore volume within the sample that is occupied by pores within a given range of pore diameters, one would: (1) calculate the area under the curve that spans the given range over the x-axis, and (2) divide the area calculated in step (1) by the total area under the curve. Optionally, in cases where the article includes pore sizes that lie outside the range of pore sizes that can be accurately measured using ASTM standard D4284-07, porosimetry measurements may be supplemented using BET surface analysis, as described, for example, in S. Brunauer, P. H. Emmett, and E. Teller, J. Am. Chem. Soc., 1938, 60, 309, which is incorporated herein by reference in its entirety.

In some embodiments, the electrochemical cell may comprise a separator, and the separator may comprise pores with relatively uniform cross-sectional diameters. Not wishing to be bound by any theory, such uniformity may be useful in maintaining relatively consistent structural stability throughout the bulk of the layer. In addition, the ability to control the pore size to within a relatively narrow range can allow one to incorporate a large number of pores that are large enough to allow for fluid penetration (e.g., electrolyte penetration, or penetration of a liquid component of the electrolyte) while maintaining sufficiently small pores to preserve structural stability of the porous material. In some embodiments, the distribution of the cross-sectional diameters of the pores within the separator can have a standard deviation of less than about 50%, less than about 25%, less than about 10%, less than about 5%, less than about 2%, or less than about 1% of the average cross-sectional diameter of the plurality of pores. Standard deviation (lower-case sigma) is given its normal meaning in the art, and can be calculated as:

$$σ = \sqrt{\frac{{\sum }_{i - 1}^{n} {( {D}_{i} - {D}_{avg} )}^{2}}{n - 1}}$$

wherein Dᵢ is the cross-sectional diameter of pore i, D_{avg} is the average of the cross-sectional diameters of the plurality of pores, and n is the number of pores. The percentage comparisons between the standard deviation and the average cross-sectional diameters of the pores outlined above can be obtained by dividing the standard deviation by the average and multiplying by 100%.

In some embodiments, a composite may comprise a separator and the separator may comprise one or more polymers. Non-limiting examples of suitable polymers include polyamines (e.g., poly(ethylene imine) and polypropylene imine (PPI)); polyamides (e.g., polyamide (Nylon), poly(e-caprolactam) (Nylon 6), poly(hexamethylene adipamide) (Nylon 66)), polyimides (e.g., polyimide, polynitrile, and poly(pyromellitimide-1,4-diphenyl ether) (Kapton)); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, poly(styrene)-poly(butadiene) copolymers, and poly(isohexylcynaoacrylate)); polyacetals; polyolefins (e.g., poly(butene-1), poly(n-pentene-2), polyethylene, polypropylene, polytetrafluoroethylene); polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), poly(vinylidene fluoride) and poly(vinylidene fluoride-hexafluoropropylene) copolymers); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); nitrocellulose; carboxymethyl cellulose; and inorganic polymers (e.g., polyphosphazene, polyphosphonate, polysilanes, polysilazanes). In some embodiments, the polymer may be selected from the group consisting of polyvinyl alcohol, polyisobutylene, epoxy, polyethylene, polypropylene, polytetrafluoroethylene, and combinations thereof.

In some embodiments, a composite may comprise a separator and the separator may comprise one or more non-polymeric materials. In certain embodiments, the separator may comprise a ceramic. For example, a ceramic coating may be applied to the separator, a ceramic material may be present throughout the thickness of the separator, and/or the separator may comprise a ceramic layer or layers. The ceramic layer or layers may be positioned on external surface(s) of the separator, or may be surrounded by polymer layers. In some embodiments, a separator comprises a polymer layer, a ceramic layer disposed on the polymer layer, and a layer comprising lithium (and/or sodium and/or magnesium) disposed on the ceramic layer. Some non-limiting examples of suitable ceramics include alumina, boehmite, oxides, and ceramics that conduct lithium ions.

In some embodiments, a composite comprises a separator and an ionically conductive compound, such as an ionically conductive ceramic and/or an ionically conductive glass, disposed on the separator. A layer comprising lithium (and/or sodium and/or magnesium) may be disposed, directly or indirectly, on the ionically conductive compound. In some embodiments, a composite comprises a separator comprising a polymeric material and a layer comprising an ionically conductive compound disposed, directly or indirectly, on the polymeric material, and a layer comprising lithium (and/or sodium and/or magnesium) disposed, directly or indirectly, on the layer comprising the ionically conductive compound.

In some embodiments, a composite comprises a ionically conductive compound, possibly in the form of a layer positioned between a separator comprising a polymeric material and a layer comprising lithium (and/or sodium and/or magnesium), with the composition LiₓMP_{y}S_{z} (where x, y, and z are integers, e.g., integers less than 32; and where M=Sn, Ge, or Si), such as Li₂₂SiP₂S₁₈, Li₂₄MP₂S₁₉, or LiMP₂S₁₂ (e.g., where M=Sn, Ge, Si) and LiSiPS.

In some embodiments, a composite comprises a ionically conductive compound, possibly in the form of a layer positioned between a separator comprising a polymeric material and a layer comprising lithium (and/or sodium and/or magnesium), comprising a compound having a composition as in formula (I):

Li₂ₓS_{x+w+5z}M_{y}P_{2z} (I),

where x is 8-16, y is 0.1-6, w is 0.1-15, z is 0.1-3, and M is selected from the group consisting of Lanthanides, Group 3, Group 4, Group 5, Group 6, Group 7, Group 8, Group 9, Group 12, Group 13, and Group 14 atoms, and combinations thereof.

In some embodiments, the ionically conductive compound has a composition as in formula (I) and x is 8-16, 8-12, 10-12, 10-14, or 12-16. In some embodiments x is 8 or greater, 8.5 or greater, 9 or greater, 9.5 or greater, 10 or greater, 10.5 or greater, 11 or greater, 11.5 or greater, 12 or greater, 12.5 or greater, 13 or greater, 13.5 or greater, 14 or greater, 14.5 or greater, 15 or greater, or 15.5 or greater. In certain embodiments, x is less than or equal to 16, less than or equal to 15.5, less than or equal to 15, less than or equal to 14.5, less than or equal to 14, less than or equal to 13.5, less than or equal to 13, less than or equal to 12.5, less than or equal to 12, less than or equal to 11.5, less than or equal to 11, less than or equal to 10.5, less than or equal to 10, less than or equal to 9.5, or less than or equal to 9. Combinations of the above referenced ranges are also possible (e.g., greater than or equal to 8 and less than or equal to 16, greater than or equal to 10 and less than or equal to 12). Other ranges are also possible. In some embodiments, x is 10. In certain embodiments, x is 12.

In certain embodiments, the ionically conductive compound has a composition as in formula (I) and y is 0.1-6, 0.1-1, 0.1-3, 0.1-4.5, 0.1-6, 0.8-2, 1-4, 2-4.5, 3-6 or 1-6. For example, in some embodiments, y is 1. In some embodiments, y is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, greater than or equal to 2.8, greater than or equal to 3.0, greater than or equal to 3.5, greater than or equal to 4.0, greater than or equal to 4.5, greater than or equal to 5.0, or greater than or equal to 5.5. In certain embodiments, y is less than or equal to 6, less than or equal to 5.5, less than or equal to 5.0, less than or equal to 4.5, less than or equal to 4.0, less than or equal to 3.5, less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 6.0, greater than or equal to 1 and less than or equal to 6, greater than or equal to 1 and less than or equal to 3, greater than or equal to 0.1 and less than or equal to 4.5, greater than or equal to 1.0 and less than or equal to 2.0). Other ranges are also possible. In embodiments in which a compound of formula (I) includes more than one M, the total y may have a value in one or more of the above-referenced ranges and in some embodiments may be in the range of 0.1-6.

In some embodiments, the ionically conductive compound has a composition as in formula (I) and z is 0.1-3, 0.1-1, 0.8-2, or 1-3. For example, in some embodiments, z is 1. In some embodiments, z is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.2, greater than or equal to 1.4, greater than or equal to 1.5, greater than or equal to 1.6, greater than or equal to 1.8, greater than or equal to 2.0, greater than or equal to 2.2, greater than or equal to 2.4, greater than or equal to 2.5, greater than or equal to 2.6, or greater than or equal to 2.8. In certain embodiments, z is less than or equal to 3.0, less than or equal to 2.8, less than or equal to 2.6, less than or equal to 2.5, less than or equal to 2.4, less than or equal to 2.2, less than or equal to 2.0, less than or equal to 1.8, less than or equal to 1.6, less than or equal to 1.5, less than or equal to 1.4, less than or equal to 1.2, less than or equal to 1.0, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 3.0, greater than or equal to 1.0 and less than or equal to 2.0). Other ranges are also possible.

In certain embodiments, the ionically conductive compound has a composition as in formula (I) and the ratio of y to z is greater than or equal to 0.03, greater than or equal to 0.1, greater than or equal to 0.25, greater than or equal to 0.5, greater than or equal to 0.75, greater than or equal to 1, greater than or equal to 2, greater than or equal to 4, greater than or equal to 8, greater than or equal to 10, greater than or equal to 15, greater than or equal to 20, greater than or equal to 25, greater than or equal to 30, greater than or equal to 40, greater than or equal to 45, or greater than or equal to 50. In some embodiments, the ratio of y to z is less than or equal to 60, less than or equal to 50, less than or equal to 45, less than or equal to 40, less than or equal to 30, less than or equal to 25, less than or equal to 20, less than or equal to 15, less than or equal to 10, less than or equal to 8, less than or equal to 4, less than or equal to 3, less than or equal to 2, less than or equal to 1, less than or equal to 0.75, less than or equal to 0.5, less than or equal to 0.25, or less than or equal to 0.1. Combinations of the above-referenced ranges are also possible (e.g., a ratio of y to z of greater than or equal to 0.1 and less than or equal to 60, a ratio of y to z of greater than or equal to 0.1 and less than or equal to 10, greater than or equal to 0.25 and less than or equal to 4, or greater than or equal to 0.75 and less than or equal to 2). In some embodiments, the ratio of y to z is 1.

In some embodiments, the ionically conductive compound has a composition as in formula (I) and w is 0.1-15, 0.1-1, 0.8-2, 1-3, 1.5-3.5, 2-4, 2.5-5, 3-6, 4-8, 6-10, 8-12, or 10-15. For example, in some embodiments, w is 1. In some cases, w may be 1.5. In certain embodiments, w is 2. In some embodiments, w is greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.5, greater than or equal to 2, greater than or equal to 2.5, greater than or equal to 3, greater than or equal to 4, greater than or equal to 6, greater than or equal to 8, greater than or equal to 10, greater than or equal to 12, or greater than or equal to 14. In certain embodiments, w is less than or equal to 15, less than or equal to 14, less than or equal to 12, less than or equal to 10, less than or equal to 8, less than or equal to 6, less than or equal to 4, less than or equal to 3, less than or equal to 2.5, less than or equal to 2, less than or equal to 1.5, less than or equal to 1, less than or equal to 0.8, less than or equal to 0.6, less than or equal to 0.5, less than or equal to 0.4, or less than or equal to 0.2. Combinations of the above-referenced ranges are also possible (e.g., greater than or equal to 0.1 and less than or equal to 15, greater than or equal to 1.0 and less than or equal to 3.0). Other ranges are also possible.

In an exemplary embodiment, the ionically conductive compound has a composition as in Li₁₆S₁₅MP₂. In another exemplary embodiment, the ionically conductive compound has a composition as in Li₂₀S₁₇MP₂. In yet another exemplary embodiment, the ionically conductive compound has a composition as in Li₂₁S₁₇Si₂P.

In yet another exemplary embodiment, the ionically conductive compound has a composition as in Li₂₄S₁₉MP₂. For example a ionically conductive compound according to the present invention may have a composition according to a formula selected from the group consisting of Li₁₆S₁₅MP₂, Li₂₀S₁₇MP₂ and Li₂₄S₁₉MP₂.

In some embodiments, the ionically conductive compound has a composition as in formula (I) and w is equal to y. In certain embodiments, w is equal to 1.5y. In other embodiments, w is equal to 2y. In yet other embodiments, w is equal to 2.5y. In yet further embodiments, w is equal to 3y. Without wishing to be bound by theory, those skilled in the art would understand that the value of w may, in some cases, depend upon the valency of M. For example, in some embodiments, M is a tetravalent atom, w is 2y, and y is 0.1-6. In certain embodiments, M is a trivalent atom, w is 1.5y, and y is 0.1-6. In some embodiments, M is a bivalent atom, w is equal to y, and y is 0.1-6. Other valences and values for w are also possible.

In some embodiments, the ionically conductive compound has a composition as in formula (I) and M is tetravalent, x is 8-16, y is 0.1-6, w is 2y, and z is 0.1-3. In some such embodiments, the ionically conductive compound has a composition as in formula (II):

Li₂ₓS_{x+2y+5z}M_{y}P_{2z} (II),

where x is 8-16, y is 0.1-6, z is 0.1-3, and M is tetravalent and selected from the group consisting of Lanthanides, Group 4, Group 8, Group 12, and Group 14 atoms, and combinations thereof. In an exemplary embodiment, M is Si, x is 10.5, y is 1, and z is 1 such that the compound of formula (II) is Li₂₁S_{17.5}SiP₂.

In some embodiments, the ionically conductive compound has a composition as in formula (I) and M is trivalent, x is 8-16, y is 1, w is 1.5y, and z is 1. In some such embodiments, the ionically conductive compound has a composition as in formula (III):

Li₂ₓS_{x+1.5y+5z}M_{y}P_{2z} (III),

where x is 8-16, y is 0.1-6, z is 0.1-3, and M in any one of formulas (I)-(III) is trivalent and selected from the group consisting of Lanthanides, Group 3, Group 4, Group 5, Group 6, Group 7, Group 8, Group 9, Group 12, Group 13, and Group 14 atoms, and combinations thereof. In an exemplary embodiment, M is Ga, x is 10.5, y is 1, and z is 1 such that the compound of formula (III) is Li₂₁S₁₇GaP₂.

In some embodiments, the ionically conductive compound has a composition as in formula (I) and M is a Group 4 (i.e. IUPAC Group 4) atom such as zirconium. In certain embodiments, M is a Group 8 (i.e. IUPAC Group 8) atom such as iron. In some embodiments, M is a Group 12 (i.e. IUPAC Group 12) atom such as zinc. In certain embodiments, M is a Group 13 (i.e. IUPAC Group 13) atom such as aluminum. In some embodiments, M is a Group 14 (i.e. IUPAC Group 14) atom such as silicon, germanium, or tin. In some cases, M may be selected from the groups consisting of Lanthanides, Group 3, Group 4, Group 5, Group 6, Group 7, Group 8, Group 9, Group 12, Group 13, and/or Group 14 atoms. For example, in some embodiments, M may be selected from silicon, tin, germanium, zinc, iron, zirconium, aluminum, and combinations thereof. In certain embodiments, M is selected from silicon, germanium, aluminum, iron and zinc. In some embodiments, M is a transition metal atom.

In some cases, the ionically conductive compound has a composition as in formula (I) and M may be a combination of two or more atoms selected from the groups consisting of Lanthanides, Group 3, Group 4, Group 5, Group 6, Group 7, Group 8, Group 9, Group 12, Group 13, and Group 14 atoms. That is, in certain embodiments in which M includes more than one atom, each atom (i.e. each atom M) may be independently selected from the group consisting of Lanthanides, Group 3, Group 4, Group 5, Group 6, Group 7, Group 8, Group 9, Group 12, Group 13, and Group 14 atoms. In some embodiments, M is a single atom. In certain embodiments, M is a combination of two atoms. In other embodiments, M is a combination of three atoms. In some embodiments, M is a combination of four atoms. In some embodiments, M may be a combination of one or more monovalent atoms, one or more bivalent atoms, one or more trivalent atoms, and/or one or more tetravalent atoms selected from the groups consisting of Lanthanides, Group 3, Group 4, Group 5, Group 6, Group 7, Group 8, Group 9, Group 12, Group 13, and Group 14 atoms.

In such embodiments, the stoichiometric ratio of each atom in M may be such that the total amount of atoms present in M is y and is 0.1-6, or any other suitable range described herein for y. For example, in some embodiments, M is a combination of two atoms such that the total amount of the two atoms present in M is y and is 0.1-6. In certain embodiments, each atom is present in M in substantially the same amount and the total amount of atoms present in M is y and within the range 0.1-6, or any other suitable range described herein for y. In other embodiments, each atom may be present in M in different amounts and the total amount of atoms present in M is y and within the range 0.1-6, or any other suitable range described herein for y. In an exemplary embodiment, the ionically conductive compound has a composition as in formula (I) and each atom in M is either silicon or germanium and y is 0.1-6. For example, in such an embodiment, each atom in M may be either silicon or germanium, each present in substantially the same amount, and y is 1 since M_{y} is Si_{0.5}Ge_{0.5}. In another exemplary embodiment, the ionically conductive compound has a composition as in formula (I) and each atom in M may be either silicon or germanium, each atom present in different amounts such that M_{y} is Si_{y-p}Geₚ, where p is between 0 and y (e.g., y is 1 and p is 0.25 or 0.75). Other ranges and combinations are also possible. Those skilled in the art would understand that the value and ranges of y, in some embodiments, may depend on the valences of M as a combination of two or more atoms, and would be capable of selecting and/or determining y based upon the teachings of this specification. As noted above, in embodiments in which a compound of formula (I) includes more than one atom in M, the total y may be in the range of 0.1-6.

In an exemplary embodiment, the ionically conductive compound has a composition as in formula (I) and M is silicon. For example, in some embodiments, the ionically conductive compound is Li₂ₓS_{x+w+5z}Si_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each x, y and z may independently be chosen from the values and ranges of x, y and z described above, respectively. For example, in one particular embodiment, x is 10, y is 1, and z is 1, and the ionically conductive compound is Li₂₀S₁₇SiP₂. In some embodiments, x is 10.5, y is 1, and z is 1, and the ionically conductive compound is Li₂₁S_{17.5}SiP₂. In certain embodiments, x is 11, y is 1, and z is 1, and the ionically conductive compound is Li₂₂S₁₈SiP₂. In certain embodiments, x is 12, y is 1, and z is 1, and the ionically conductive compound is Li₂₄S₁₉SiP₂. In some cases, x is 14, y is 1, and z is 1, and the ionically conductive compound is Li₂₈S₂₁SiP₂.

In yet another exemplary embodiment, the ionically conductive compound has a composition as in formula (I) and M is a combination of two atoms, wherein the first atom is Si and the second atom is selected from the groups consisting of Lanthanides, Group 3, Group 4, Group 5, Group 6, Group 7, Group 8, Group 9, Group 12, Group 13, and Group 14 atoms. For example, in some embodiments, the ionically conductive compound is Li₂ₓS_{x+w+5z}SiₐQ_{b}P_{2z} where Q is selected from the groups consisting of Lanthanides, Group 3, Group 4, Group 5, Group 6, Group 7, Group 8, Group 9, Group 12, Group 13, and Group 14 atoms, a+b=y, and each w, x, y and z may independently be chosen from the values and ranges of w, x, y and z described above, respectively. In some embodiments, the ionically conductive compound is Li₂₁La_{0.5}Si_{1.5}PS_{16.75}. In certain embodiments, the ionically conductive compound is Li₂₁LaSiPS_{16.5}. In certain embodiments, the ionically conductive compound is Li₂₁AlSiPS_{16.5}. In certain embodiments, the ionically conductive compound is Li₂₁Al_{0.5}Si_{1.5}PS_{16.75}. In certain embodiments, the ionically conductive compound is Li₂₁AlSi₂S₁₆. In certain embodiments, the ionically conductive compound is Li₂₁BP₂S₁₇.

It should be appreciated that while much of the above description herein relates to ionically conductive compounds with any one of formulas (I)-(III) where y is 1, z is 1, w is 2y, and comprises silicon, other combinations of values for w, x, y, and z and elements for M are also possible. For example, in some cases, M is Ge and the ionically conductive compound may be Li₂ₓS_{x+w+5z}Ge_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the ionically conductive compound is Li₂₀S₁₇GeP₂. In certain embodiments, w is 2, x is 12, y is 1, and z is 1, and the ionically conductive compound is Li₂₄S₁₉GeP₂. In some cases, w is 2, x is 14, y is 1, and z is 1, and the ionically conductive compound is Li₂₈S₂₁GeP₂. Other stoichiometric ratios, as described above, are also possible.

In certain embodiments, the ionically conductive compound has a composition as in any one of formulas (I)-(III) and M is Sn and the ionically conductive compound may be Li₂ₓS_{x+w+5z}Sn_{y}P_{2z}, where x is greater than or equal to 8 and less than or equal to 16, y is greater than or equal to 0.1 and less than or equal to 3, w is equal to 2y, and z is greater than or equal to 0.1 and less than or equal to 3. Each w, x, y and z may independently be chosen from the values and ranges of w, x, y and z described above, respectively. For example, in one particular embodiment, w is 2, x is 10, y is 1, and z is 1, and the ionically conductive compound is Li₂₀S₁₇SnP₂. In certain embodiments, w is 2, x is 12, y is 1, and z is 1, and the ionically conductive compound is Li₂₄S₁₉SnP₂. In some cases, w is 2, x is 14, y is 1, and z is 1, and the ionically conductive compound is Li₂₈S₂₁SnP₂. Other stoichiometric ratios, as described above, are also possible.

In an exemplary embodiment, the ionically conductive compound has a composition as in formula (I):

Li₂ₓS_{x+w+5z}M_{y}P_{2z} (I)

wherein x is 5-14, y is 1-2, z is 0.5-1, (x+w+5z) is 12-21, and M is selected from the group consisting of Si, Ge, La, Al, B, Ga, and combinations thereof (e.g., such that M_{y} is La_{0.5}Si₁₅, LaSi, AlSi, Al_{0.5}Si_{1.5}, or AlSi₂). Non-limiting examples of compounds having a composition as in formula (I) include Li₁₀S₁₂SiP₂, Li₁₂S₁₃SiP₂, Li₁₆S₁₅SiP₂, Li₂₀S₁₇SiP₂, Li₂₁S₁₇Si₂P, Li₂₁S_{17.5}SiP₂, Li₂₂S₁₈SiP₂, Li₂₄S₁₉SiP₂, Li₂₈S₂₁SiP₂, Li₂₄S₁₉GeP₂, Li₂₁SiP₂S_{17.5}, Li₂₁La_{0.5}Si_{1.5}PS_{16.75}, Li₂₁LaSiPS_{16.5}, Li₂₁La₂PS₁₆, Li₂₁AlP₂S₁₇, Li₁₇AlP₂S₁₅, Li₁₇Al₂PS₁₄, Li₁₁AlP₂S₁₂, Li₁₁AlP₂S₁₂, Li₂₁AlSiPS_{16.5}, Li₂₁Al_{0.5}Si_{1.5}PS_{16.75}, Li₂₁AlSi₂S₁₆, Li₂₁BP₂S₁₇, and Li₂₁GaP₂S₁₇. Other compounds are also possible.

In certain embodiments, a layer comprising the compound of formula (I) is substantially crystalline. In some embodiments, the layer comprising the compound of formula (I) is at least partially amorphous. In certain embodiments, the layer comprising the compound of formula (I) is between 1 wt % and 100 wt % crystalline. That is to say, in some embodiments, the crystalline fraction of the compound of formula (I) comprised by the layer (or particles) is in the range of 1% to 100% based on the total weight of the compound of formula (I) comprised by the layer (or particles). In certain embodiments, the layer comprising the compound of formula (I) is greater than or equal to 1 wt %, greater than or equal to 2 wt %, greater than or equal to 5 wt., greater than or equal to 10 wt %, greater than or equal to 20 wt %, greater than or equal to 25 wt %, greater than or equal to 50 wt %, greater than or equal to 75 wt %, greater than or equal to 90 wt %, greater than or equal to 95 wt %, greater than or equal to 98 wt %, greater than or equal to 99 wt %, or greater than or equal to 99.9 wt % crystalline. In certain embodiments, the layer comprising the compound of formula (I) is less than or equal to 99.9 wt %, less than or equal to 98 wt %, less than or equal to 95 wt %, less than or equal to 90 wt %, less than or equal to 75 wt %, less than or equal to 50 wt %, less than or equal to 25 wt %, less than or equal to 20 wt %, less than or equal to 10 wt %, less than or equal to 5 wt %, or less than or equal to 2 wt % crystalline.

In some embodiments, a layer comprising the compound of formula (I) is greater than or equal to 99.2 wt %, greater than or equal to 99.5 wt %, greater than or equal to 99.8 wt %, or greater than or equal to 99.9 wt % crystalline. In some cases, a layer comprising the compound of formula (I) may be 100 wt % crystalline. Combinations of the above referenced ranges are also possible (e.g., greater than or equal to 1 wt % and less than or equal to 100 wt %, greater than or equal to 50 wt % and less than or equal to 100 wt %).

In some embodiments, the compound of formula (I) has a cubic crystal structure. Unless indicated otherwise, the crystal structure and/or percent crystallinity as used herein is determined by x-ray diffraction crystallography at a wavelength of 1.541 nm using a synchrotron of particles comprising the compound. In some instances, Raman spectroscopy may be used.

In some embodiments, a composite comprises a ionically conductive compound, possibly in the form of a layer, with the composition as in formula (IV):

LiₓM_{y}Q_{w}P_{z}SᵤXₜ (IV),

wherein M is selected from the group consisting of Na, K, Fe, Mg, Ag, Cu, Zr, and Zn, wherein Q is absent or selected from the group consisting of Cr, B, Sn, Ge, Si, Zr, Ta, Nb, V, P, Fe, Ga, Al, As, and combinations thereof, wherein X is absent or selected from the group consisting of halide and pseudohalide, and wherein x is 8-22, y is 0.1-3, w is 0-3, z is 0.1-3, u is 7-20, t is 0-8. In some embodiments, Q, when present, is different than M.

In some embodiments, the ionically conductive compound has a composition as in formula (IV) and x is 8-22, 8-16, 8-12, 10-12, 10-14, 12-16, 14-18, 16-20, or 18-22. In some embodiments x is 8 or greater, 8.5 or greater, 9 or greater, 9.5 or greater, 10 or greater, 10.5 or greater, 11 or greater, 11.5 or greater, 12 or greater, 12.5 or greater, 13 or greater, 13.5 or greater, 14 or greater, 14.5 or greater, 15 or greater, 15.5 or greater, 16 or greater, 16.5 or greater, 17 or greater, 17.5 or greater, 18 or greater, 18.5 or greater, 19 or greater, 19.5 or greater, 20 or greater, 20.5 or greater, 21 or greater, or 21.5 or greater. In certain embodiments, x is less than or equal to 22, less than or equal to 21.5, less than or equal to 21, less than or equal to 20.5, less than or equal to 20, less than or equal to 19.5, less than or equal to 19, less than or equal to 18.5, less than or equal to 18, less than or equal to 17.5, less than or equal to 17, less than or equal to 16.5, less than or equal to 16, less than or equal to 15.5, less than or equal to 15, less than or equal to 14.5, less than or equal to 14, less than or equal to 13.5, less than or equal to 13, less than or equal to 12.5, less than or equal to 12, less than or equal to 11.5, less than or equal to 11, less than or equal to 10.5, less than or equal to 10, less than or equal to 9.5, or less than or equal to 9. Combinations of the above referenced ranges are also possible (e.g., greater than or equal to 8and less than or equal to 22, greater than or equal to 10 and less than or equal to 12). Other ranges are also possible. In some embodiments, x is 10. In certain embodiments, x is 11. In some cases, x is 12. In certain embodiments, x is 13. In some embodiments, x is 14. In some cases, x is 18. In certain embodiments, x is 22.

In certain embodiments, the ionically conductive compound has a composition as in formula (IV) and y is 0.1-3, 0.1-1, 0.1-1.5, 0.1-2, 0.5-3, 0.8-3, 1-3, or 2-3. For example, in some embodiments, y is 1. In some embodiments, y is greater than or equal to 0.1, greater than or equal to 0.2, greater than or equal to 0.25, greater than or equal to 0.4, greater than or equal to 0.5, greater than or equal to 0.6, greater than or equal to 0.75, greater than or equal to 0.8, greater than or equal to 1, greater than or equal to 1.2, greater than or equal to 1.25, greater than or equal to 1.4, greater than or equal to 1.5, greater than or equal to 1.6, greater than or equal to 1.75, greater than or equal to 1.8, greater than or equal to 2.0, greater than or equal to 2.25, greater than or equal to 2.4, greater than or equal to 2.5, greater than or equal to 2.6, greater than or equal to 2.75, or greater than or equal to 2.8. In certain embodiments, y is less than or equal to 3.0, less than or equal to 2.8, less than or equal to 2.75, less than or equal to 2.6, less than or equal to 2.5, less than or equal to 2.4, less than or equal to 2.25, less than or equal to 2.2, less than or equal to 2.0, less than or equal to 1.8, less than or equal to 1.75, less than or equal to 1.6, less than or equal to 1.5, less than or equal to 1.4, less than or equal to 1.25, less than or equal to 1.2, less than or equal to 1.0, less than or equal to 0.8, less than or equal to 0.75, less than or equal to 0.6, less than or equal to 0.5, less than or equal to 0.4, less than or equal to 0.25, or less than or equal to 0.2. Combinations of the above-referenced ranges are also possible (e.g., greater than or equal to 0.1 and less than or equal to 3.0, greater than or equal to 1 and less than or equal to 3, greater than or equal to 0.1 and less than or equal to 2.5, greater than or equal to 1.0 and less than or equal to 2.0). Other ranges are also possible. In an exemplary embodiment, y is 1. In another exemplary embodiment, y is 0.5. In some embodiments, y is 0.75.

In certain embodiments, the ionically conductive compound has a composition as in formula (IV) and w is 0-3, 0.1-3, 0.1-1, 0.1-1.5, 0.1-2, 0.5-3, 0.8-3, 1-3, or 2-3. For example, in some embodiments, w is 1. In some embodiments, w is greater than or equal to 0, greater than or equal to 0.1, greater than or equal to 0.2, greater than or equal to 0.25, greater than or equal to 0.4, greater than or equal to 0.5, greater than or equal to 0.6, greater than or equal to 0.75, greater than or equal to 0.8, greater than or equal to 1, greater than or equal to 1.2, greater than or equal to 1.25, greater than or equal to 1.4, greater than or equal to 1.5, greater than or equal to 1.6, greater than or equal to 1.75, greater than or equal to 1.8, greater than or equal to 2.0, greater than or equal to 2.25, greater than or equal to 2.4, greater than or equal to 2.5, greater than or equal to 2.6, greater than or equal to 2.75, or greater than or equal to 2.8. In certain embodiments, w is less than or equal to 3.0, less than or equal to 2.8, less than or equal to 2.75, less than or equal to 2.6, less than or equal to 2.5, less than or equal to 2.4, less than or equal to 2.25, less than or equal to 2.2, less than or equal to 2.0, less than or equal to 1.8, less than or equal to 1.75, less than or equal to 1.6, less than or equal to 1.5, less than or equal to 1.4, less than or equal to 1.25, less than or equal to 1.2, less than or equal to 1.0, less than or equal to 0.8, less than or equal to 0.75, less than or equal to 0.6, less than or equal to 0.5, less than or equal to 0.4, less than or equal to 0.25, less than or equal to 0.2, or less than or equal to 0.1. Combinations of the above-referenced ranges are also possible (e.g., greater than or equal to 0 and less than or equal to 3, greater than or equal to 0.1 and less than or equal to 3.0, greater than or equal to 1 and less than or equal to 3, greater than or equal to 0.1 and less than or equal to 2.5, greater than or equal to 1.0 and less than or equal to 2.0). Other ranges are also possible. In an exemplary embodiment, w is 1. In another exemplary embodiment, w is 0.5. In some embodiments, w is 0.75. In some cases, w is 0.

In certain embodiments, the ionically conductive compound has a composition as in formula (IV) and z is 0.1-3, 0.1-1, 0.1-1.5, 0.1-2, 0.5-3, 0.8-3, 1-3, or 2-3. For example, in some embodiments, z is 1. In some embodiments, z is greater than or equal to 0.1, greater than or equal to 0.2, greater than or equal to 0.25, greater than or equal to 0.4, greater than or equal to 0.5, greater than or equal to 0.6, greater than or equal to 0.75, greater than or equal to 0.8, greater than or equal to 1, greater than or equal to 1.2, greater than or equal to 1.25, greater than or equal to 1.4, greater than or equal to 1.5, greater than or equal to 1.6, greater than or equal to 1.75, greater than or equal to 1.8, greater than or equal to 2.0, greater than or equal to 2.25, greater than or equal to 2.4, greater than or equal to 2.5, greater than or equal to 2.6, greater than or equal to 2.75, or greater than or equal to 2.8. In certain embodiments, z is less than or equal to 3.0, less than or equal to 2.8, less than or equal to 2.75, less than or equal to 2.6, less than or equal to 2.5, less than or equal to 2.4, less than or equal to 2.25, less than or equal to 2.2, less than or equal to 2.0, less than or equal to 1.8, less than or equal to 1.75, less than or equal to 1.6, less than or equal to 1.5, less than or equal to 1.4, less than or equal to 1.25, less than or equal to 1.2, less than or equal to 1.0, less than or equal to 0.8, less than or equal to 0.75, less than or equal to 0.6, less than or equal to 0.5, less than or equal to 0.4, less than or equal to 0.25, or less than or equal to 0.2. Combinations of the above-referenced ranges are also possible (e.g., greater than or equal to 0.1 and less than or equal to 3.0, greater than or equal to 1 and less than or equal to 3, greater than or equal to 0.1 and less than or equal to 2.5, greater than or equal to 1.0 and less than or equal to 2.0). Other ranges are also possible. In an exemplary embodiment, z is 1. In another exemplary embodiment, z is 2.

In certain embodiments, the ionically conductive compound has a composition as in formula (IV) and u is 7-20, 7-10, 8-14, 10-16, 12-18, or 14-20. For example, in some embodiments, u is greater than or equal to 7, greater than or equal to 7.5, greater than or equal to 8, greater than or equal to 8.5, greater than or equal to 9, greater than or equal to 9.5, greater than or equal to 10, greater than or equal to 10.25, greater than or equal to 10.5, greater than or equal to 10.75, greater than or equal to 11, greater than or equal to 11.25, greater than or equal to 11.5, greater than or equal to 11.75, greater than or equal to 12, greater than or equal to 12.25, greater than or equal to 12.5, greater than or equal to 12.75, greater than or equal to 13, greater than or equal to 13.25, greater than or equal to 13.5, greater than or equal to 13.75, greater than or equal to 14, greater than or equal to 14.25, greater than or equal to 14.5, greater than or equal to 14.75, greater than or equal to 15, greater than or equal to 15.25, greater than or equal to 15.5, greater than or equal to 15.75, greater than or equal to 16, greater than or equal to 16.5, greater than or equal to 17, greater than or equal to 17.5, greater than or equal to 18, greater than or equal to 18.5, greater than or equal to 19, or greater than or equal to 19.5. In certain embodiments, u is less than or equal to 20, less than or equal to 19.5, less than or equal to 19, less than or equal to 18.5, less than or equal to 18, less than or equal to 17.5, less than or equal to 17, less than or equal to 16.5, less than or equal to 16, less than or equal to 15.75, less than or equal to 15.5, less than or equal to 15.25, less than or equal to 15, less than or equal to 14.75, less than or equal to 14.5, less than or equal to 14.25, less than or equal to 14, less than or equal to 13.75, less than or equal to 13.5, less than or equal to 13.25, less than or equal to 13, less than or equal to 12.75, less than or equal to 12.5, less than or equal to 12.25, less than or equal to 12, less than or equal to 11.75, less than or equal to 11.5, less than or equal to 11.25, less than or equal to 11, less than or equal to 10.75, less than or equal to 10.5, less than or equal to 10.25, less than or equal to 10, less than or equal to 9.5, less than or equal to 9, less than or equal to 8.5, less than or equal to 8, or less than or equal to 7.5. Combinations of the above-referenced ranges are also possible (e.g., greater than or equal to 7 and less than or equal to 20, greater than or equal to 11 and less than or equal to 18). Other ranges are also possible.

In some embodiments, the ionically conductive compound has a composition as in formula (IV) and t is 0-8, 0.1-8, 0.1-1, 0.8-2, 1-3, 1.5-3.5, 2-4, 2.5-5, 3-6, or 4-8. For example, in some embodiments, t is 1. In some cases, t may be 2. In certain embodiments, t is 3. In some embodiments, t is greater than or equal to 0, greater than or equal to 0.1, greater than or equal to 0.2, greater than or equal to 0.4, greater than or equal to 0.5, greater than or equal to 0.6, greater than or equal to 0.8, greater than or equal to 1, greater than or equal to 1.5, greater than or equal to 2, greater than or equal to 2.5, greater than or equal to 3, greater than or equal to 4, greater than or equal to 5, greater than or equal to 6, or greater than or equal to 7. In certain embodiments, t is less than or equal to 8, less than or equal to 7, less than or equal to 6, less than or equal to 5, less than or equal to 4, less than or equal to 3, less than or equal to 2.5, less than or equal to 2, less than or equal to 1.5, less than or equal to 1, less than or equal to 0.8, less than or equal to 0.6, less than or equal to 0.5, less than or equal to 0.4, less than or equal to 0.2, or less than or equal to 0.1. Combinations of the above-referenced ranges are also possible (e.g., greater than or equal to 0 and less than or equal to 8, greater than or equal to 0.1 and less than or equal to 8, greater than or equal to 1 and less than or equal to 3). Other ranges are also possible.

In some embodiments, M in formula (IV) is selected from the group consisting of monovalent cations, bivalent cations, trivalent cations, tetravalent cations, and pentavalent cations. In certain embodiments, Q is absent, or Q is present and selected from the group consisting of monovalent cations, bivalent cations, trivalent cations, tetravalent cations, and pentavalent cations. In some embodiments, Q is different than M.

Non-limiting examples of suitable monovalent cations (for M in formula (IV)) include Na, K, Rb, Ag, and Cu. Non-limiting examples of suitable bivalent cations include Ca, Mg, Zn, Cu, and Fe. Non-limiting examples of suitable trivalent cations include Fe, Al, Ga, As, Cr, Mn, and B. Non-limiting examples of suitable tetravalent cations include Mn, Sn, Ge, Zr, and Si. Non-limiting examples of suitable pentavalent cations include Ta, Nb, As, V, and P. Other cations are also possible. In some cases, cations may have one or another type of valence (e.g., in some embodiments, Ga is trivalent, in other embodiments Ga is bivalent, in yet other embodiments, Ga is monovalent). Those of ordinary skill in the art would be capable of determining the one or more valences of a particular atom in the ionically conductive compounds described herein, based upon the teachings of this specification in common with general knowledge in the art.

In some embodiments, M in formula (IV) is selected from the group consisting of Na, K, Fe, Mg, Ag, Cu, Zr, and Zn. In certain embodiments, Q is absent (e.g., w=0). In other embodiments, Q is present, is different than M, and is selected from the group consisting of Cr, B, Sn, Ge, Si, Zr, Ta, Nb, V, P, Fe, Ga, Al, As, and combinations thereof.

In embodiments in which Q in formula (IV) is a combination of two or more atoms (e.g., two or more atoms selected from the group consisting of Cr, B, Sn, Ge, Si, Zr, Ta, Nb, V, P, Fe, Ga, Al, and As), the stoichiometric ratio of each atom in Q is such that the total amount of atoms present in Q is w and is 0.1-3. In certain embodiments, each atom is present in Q in substantially the same amount and the total amount of atoms present in Q is w and within the range 0.1-3. In other embodiments, each atom may be present in Q in different amounts and the total amount of atoms present in Q is w and within the range 0.1-3. For example, in such an embodiment, each atom in Q may be either silicon or germanium, each present in substantially the same amount, and w is 1 since Q_{w} is Si_{0.5}Ge_{0.5}. In another exemplary embodiment, the ionically conductive compound has a composition as in formula (IV) and each atom in Q may be either silicon or germanium, each atom present in different amounts such that Q_{w} is Si_{w-p}Geₚ, where p is between 0 and w (e.g., w is 1 and p is 0.25 or 0.75). Other ranges and combinations are also possible. Those skilled in the art would understand that the value and ranges of w, in some embodiments, may depend on the valences of Q as a combination of two or more atoms, and would be capable of selecting and/or determining w based upon the teachings of this specification. As noted above, in embodiments in which a compound of formula (IV) includes more than one atom in Q, the total w may be in the range of 0.1-3.

In some embodiments, the ionically conductive compound (e.g., a ionically conductive compound having a structure as in formula (IV)) has an argyrodite-type crystal structure. In some such embodiments, the compound of formula (IV) has a cubic crystal structure. For example, in certain embodiments, the ionically conductive compound has an argyrodite-type crystal structure in the space group F43m. The crystal structure of the ionically conductive compound may be determined as described above

In certain embodiments, when Q is present in formula (IV), at least a portion of Q and at least a portion of P in the structure each occupy a tetrahedral coordinated site in the argyrodite-type crystal structure. In some embodiments, at least a portion of Q in the compound occupies a tetrahedral coordinated site in the argyrodite-type crystal structure that would otherwise be occupied by P in the absence of Q. In some embodiments, the tetrahedral coordinated site is on Wyckoff position 4b (e.g., PS₄-tetrahedra and/or QS₄-tetrahedra located at Wyckoff position 4b). In some cases, S²⁻ ions may be on Wyckoff positions 4a and/or 4c.

In some embodiments, at least a portion of Li and at least a portion of M in the structure of formula (IV) each occupy a Rietveld Refinement lithium lattice site on the crystal structure. In certain embodiments, at least a portion of M in the compound occupies a site that would otherwise be occupied by Li in the crystal structure, in the absence of M. For example, in some embodiments, at least a portion of Li and/or at least a portion of M occupy a Rietveld Refinement 48 h lattice site on the crystal structure.

In a particular set of embodiments, M is Fe. For example, in some embodiments, the ionically conductive compound has a composition as in formula (V):

LiₓFe_{y}Q_{w}P_{z}SᵤXₜ, (V),

wherein x is 8-22, y is 0.1-3, w is 0-3, z is 0.1-3, u is 7-20, t is 0-8, wherein X is absent or selected from the group consisting of halide and pseudohalide, and wherein Q is absent or selected from the group consisting of Cr, B, Sn, Ge, Si, Zr, Ta, Nb, V, P, Ga, Al, As, and combinations thereof.

In certain embodiments, X is a halide. Non-limiting examples of suitable halides include Cl, I, F, and Br. In some embodiments, X is a pseudohalide. Non-limiting examples of suitable pseudohalides include cyanide, isocyanide, cyanate, isocyanate, and azide. Other pseudohalides are also possible.

In some embodiments, the ionically conductive compound has a composition as in formula (IV), Q is absent, M is a monovalent cation, x is 8-22, y is 0.1-3, w is 0-3, z is 0.1-3, u is 7-20, and t is 0-8. In some such embodiments, the ionically conductive compound may have a composition as in formula (VI):

Li_{2x-y+2-t}M_{y-z}P₂S_{x+6-0.5z-t} (VI),

wherein x is 8-22, y is 0.1-3, w is 0-3, z is 0.1-3, u is 7-20, t is 0-8, wherein X is absent or selected from the group consisting of halide and pseudohalide, and wherein M is a monovalent cation, such that 2x−y+2−t is 8-22, y−z is 0.1-3, and/or x+6−0.5z−t is 7-20. In some cases, the composition as in formula (VI) may have an argyrodite-type crystal structure.

In certain embodiments, the ionically conductive compound has a composition as in formula (IV), M is a monovalent cation, Q is a monovalent cation, x is 8-22, y is 0.1-3, w is 0-3, z is 0.1-3, u is 7-20, and t is 0-8. In some such embodiments, the ionically conductive compound may have a composition as in formula (VII):

Li_{2x-y+2+4w-t}M_{y-z}Q_{w}P_{2-w}S_{x+6-0.5z-t}Xₜ (VII),

wherein x is 8-22, y is 0.1-3, w is 0-3, z is 0.1-3, u is 7-20, t is 0-8, wherein X is absent or selected from the group consisting of halide and pseudohalide, wherein M is a monovalent cation, and wherein Q is a monovalent cation, such that 2x−y+2+4w−t is 8-22, y−z is 0.1-3, 2−w is 0.1-3, and/or x+6−0.5z−t is 7-20. In some cases, the composition as in formula (V) may have an argyrodite-type crystal structure.

In some embodiments, the ionically conductive compound has a composition as in formula (IV), Q is a bivalent cation, M is a monovalent cation, x is 8-22, y is 0.1-3, w is 0-3, z is 0.1-3, u is 7-20, and t is 0-8. In some such embodiments, the ionically conductive compound may have a composition as in formula (IX):

Li_{2x-y+2+3w-t}M_{y-z}Q_{w}P_{2-w}S_{x+6-0.5z-t}Xₜ (IX),

wherein x is 8-22, y is 0.1-3, w is 0-3, z is 0.1-3, u is 7-20, t is 0-8, wherein X is absent or selected from the group consisting of halide and pseudohalide, wherein M is a monovalent cation, and wherein Q is a bivalent cation, such that 2x−y+2+3w−t is 8-22, y−z is 0.1-3, 2−w is 0.1-3, and/or x+6−0.5z−t is 7-20. In some cases, the composition as in formula (IX) may have an argyrodite-type crystal structure.

In certain embodiments, the ionically conductive compound has a composition as in formula (IV), M is a monovalent cation, Q is a trivalent cation, x is 8-22, y is 0.1-3, w is 0-3, z is 0.1-3, u is 7-20, and t is 0-8. In some such embodiments, the ionically conductive compound may have a composition as in formula (X):

Li_{2x-y+2+2w-t}M_{y-z}Q_{w}P_{2-w}S_{x+6-0.5z-t}Xₜ (X),

wherein x is 8-22, y is 0.1-3, w is 0-3, z is 0.1-3, u is 7-20, t is 0-8, wherein X is absent or selected from the group consisting of halide and pseudohalide, wherein M is a monovalent cation, and wherein Q is a trivalent cation, such that 2x−y+2+2w−t is 8-22, y−z is 0.1-3, 2-w is 0.1-3, and/or x+6−0.5z−t is 7-20. In some cases, the composition as in formula (X) may have an argyrodite-type crystal structure.

In some embodiments, the ionically conductive compound has a composition as in formula (IV), Q is a tetravalent cation, M is a monovalent cation, x is 8-22, y is 0.1-3, w is 0-3, z is 0.1-3, u is 7-20, and t is 0-8. In some such embodiments, the ionically conductive compound may have a composition as in formula (XI):

Li_{2x-y+2+w-t}M_{y-z}Q_{w}P_{2-w}S_{x+6-0.5z-t}Xₜ (XI),

wherein x is 8-22, y is 0.1-3, w is 0-3, z is 0.1-3, u is 7-20, t is 0-8, wherein X is absent or selected from the group consisting of halide and pseudohalide, wherein M is a monovalent cation, and wherein Q is a tetravalent cation, such that 2x−y+2+w−t is 8-22, y−z is 0.1-3, 2−w is 0.1-3, and/or x+6−0.5z−t is 7-20. In some cases, the composition as in formula (XI) may have an argyrodite-type crystal structure.

In certain embodiments, the ionically conductive compound has a composition as in formula (IV), M is a monovalent cation, Q is a pentavalent cation, x is 8-22, y is 0.1-3 , w is 0-3, z is 0.1-3, u is 7-20, and t is 0-8. In some such embodiments, the ionically conductive compound may have a composition as in formula (XII):

Li_{2x-y+2-t}M_{y-z}Q_{w}P_{2-w}S_{x+6-0.5z-t}Xₜ (XII),

wherein x is 8-22, y is 0.1-3, w is 0-3, z is 0.1-3, u is 7-20, t is 0-8, wherein X is absent or selected from the group consisting of halide and pseudohalide, wherein M is a monovalent cation, and wherein Q is a pentavalent cation, such that 2x−y+2−t is 8-22, y−z is 0.1-3, 2−w is 0.1-3, and/or x+6−0.5z−t is 7-20. In some cases, the composition as in formula (XII) may have an argyrodite-type crystal structure.

In some embodiments, the ionically conductive compound has a composition as in formula (IV), Q is absent, M is a bivalent cation, x is 8-22, y is 0.1-3, w is 0-3, z is 0.1-3, u is 7-20, and t is 0-8. In some such embodiments, the ionically conductive compound may have a composition as in formula (XIII):

Li_{2x-2y+2-t}M_{y-z}P₂S_{x+6-z-t}Xₜ (XIII),

wherein x is 8-22, y is 0.1-3, w is 0-3, z is 0.1-3, u is 7-20, t is 0-8, wherein X is absent or selected from the group consisting of halide and pseudohalide, and wherein M is a bivalent cation, such that 2x−2y+2−t is 8-22, y−z is 0.1-3, and/or x+6−z−t is 7-20. In some cases, the composition as in formula (XIII) may have an argyrodite-type crystal structure.

In certain embodiments, the ionically conductive compound has a composition as in formula (IV), M is a bivalent cation, Q is a monovalent cation, x is 8-22, y is 0.1-3, w is 0-3, z is 0.1-3, u is 7-20, and t is 0-8. In some such embodiments, the ionically conductive compound may have a composition as in formula (XIV):

Li_{2x-2y+2+4w-t}M_{y-z}Q_{w}P_{2-w}S_{x+6-z-t}Xₜ (XIV),

wherein x is 8-22, y is 0.1-3, w is 0-3, z is 0.1-3, u is 7-20, t is 0-8, wherein X is absent or selected from the group consisting of halide and pseudohalide, wherein M is a bivalent cation, and wherein Q is a monovalent cation, such that 2x−2y+2+4w−t is 8-22, y−z is 0.1-3, 2−w is 0.1-3, and/or x+6−z−t is 7-20. In some cases, the composition as in formula (IX) may have an argyrodite-type crystal structure.

In some embodiments, the ionically conductive compound has a composition as in formula (IV), Q is a bivalent cation, M is a bivalent cation, x is 8-22, y is 0.1-3, w is 0-3, z is 0.1-3, u is 7-20, and t is 0-8. In some such embodiments, the ionically conductive compound may have a composition as in formula (XV):

Li_{2x-2y+2+3w-t}M_{y-z}Q_{w}P_{2-w}S_{x+6-z-t}Xₜ (XV),

wherein x is 8-22, y is 0.1-3, w is 0-3, z is 0.1-3, u is 7-20, t is 0-8, wherein X is absent or selected from the group consisting of halide and pseudohalide, wherein M is a bivalent cation, and wherein Q is a bivalent cation, such that 2x−2y+2+3w−t is 8-22, y−z is 0.1-3, 2−w is 0.1-3, and/or x+6−z−t is 7-20. In some cases, the composition as in formula (X) may have an argyrodite-type crystal structure.

In certain embodiments, the ionically conductive compound has a composition as in formula (IV), M is a bivalent cation, Q is a trivalent cation, x is 8-22, y is 0.1-3, w is 0-3, z is 0.1-3, u is 7-20, and t is 0-8. In some such embodiments, the ionically conductive compound may have a composition as in formula (XVI):

Li_{2x-2y+2+2w-t}M_{y-z}Q_{w}P_{2-w}S_{x+6-z-t}Xₜ (XVI),

wherein x is 8-22, y is 0.1-3, w is 0-3, z is 0.1-3, u is 7-20, t is 0-8, wherein X is absent or selected from the group consisting of halide and pseudohalide, wherein M is a bivalent cation, and wherein Q is a trivalent cation, such that 2x−2y+2+2w−t is 8-22, y−z is 0.1-3, 2−w is 0.1-3, and/or x+6−z−t is 7-20. In some cases, the composition as in formula (XVI) may have an argyrodite-type crystal structure.

In some embodiments, the ionically conductive compound has a composition as in formula (IV), Q is a tetravalent cation, M is a bivalent cation, x is 8-22, y is 0.1-3, w is 0-3, z is 0.1-3, u is 7-20, and t is 0-8. In some such embodiments, the ionically conductive compound may have a composition as in formula (XVII):

Li_{2x-2y+2+w-t}M_{y-z}Q_{w}P_{2-w}S_{x+6-z-t}Xₜ (XVII),

wherein x is 8-22, y is 0.1-3, w is 0-3, z is 0.1-3, u is 7-20, t is 0-8, wherein X is absent or selected from the group consisting of halide and pseudohalide, wherein M is a bivalent cation, and wherein Q is a tetravalent cation, such that 2x−2y+2+w−t is 8-22, y−z is 0.1-3, 2−w is 0.1-3, and/or x+6−z−t is 7-20. In some cases, the composition as in formula (XVII) may have an argyrodite-type crystal structure.

In certain embodiments, the ionically conductive compound has a composition as in formula (IV), M is a bivalent cation, Q is a pentavalent cation, x is 8-22, y is 0.1-3, w is 0-3, z is 0.1-3, u is 7-20, and t is 0-8. In some such embodiments, the ionically conductive compound may have a composition as in formula (XVIII):

Li_{2x-2y+2-t}M_{y-z}Q_{w}P_{2-w}S_{x+6-z-t}Xₜ (XVIII),

wherein x is 8-22, y is 0.1-3, w is 0-3, z is 0.1-3, u is 7-20, t is 0-8, wherein X is absent or selected from the group consisting of halide and pseudohalide, wherein M is a bivalent cation, and wherein Q is a pentavalent cation, such that 2x−2y+2−t is 8-22, y−z is 0.1-3, 2−w is 0.1-3, and/or x+6−z−t is 7-20. In some cases, the composition as in formula (XIII) may have an argyrodite-type crystal structure.

In some embodiments, the ionically conductive compound has a composition as in formula (IV), Q is absent, M is a trivalent cation, x is 8-22, y is 0.1-3, w is 0-3, z is 0.1-3, u is 7-20, and t is 0-8. In some such embodiments, the ionically conductive compound may have a composition as in formula (XIX):

Li_{2x-3y+2-t}M_{y-z}P₂S_{x+6-1.5z-t}Xₜ (XIX),

wherein x is 8-22, y is 0.1-3, w is 0-3, z is 0.1-3, u is 7-20, t is 0-8, wherein X is absent or selected from the group consisting of halide and pseudohalide, and wherein M is a trivalent cation, such that 2x−3y+2−t is 8-22, y−z is 0.1-3, and/or x+6−1.5z−t is 7-20. In some cases, the composition as in formula (XIX) may have an argyrodite-type crystal structure.

In certain embodiments, the ionically conductive compound has a composition as in formula (IV), M is a trivalent cation, Q is a monovalent cation, x is 8-22, y is 0.1-3, w is 0-3, z is 0.1-3, u is 7-20, and t is 0-8. In some such embodiments, the ionically conductive compound may have a composition as in formula (XX):

Li_{2x-3y+2+4w-t}M_{y-z}Q_{w}P_{2-w}S_{x+6-1.5z-t}Xₜ (XX),

wherein x is 8-22, y is 0.1-3, w is 0-3, z is 0.1-3, u is 7-20, t is 0-8, wherein X is absent or selected from the group consisting of halide and pseudohalide, wherein M is a trivalent cation, and wherein Q is a monovalent cation, such that 2x−3y+2+4w−t is 8-22, y−z is 0.1-3, 2−w is 0.1-3, and/or x+6−1.5z−t is 7-20. In some cases, the composition as in formula (XX) may have an argyrodite-type crystal structure.

In some embodiments, the ionically conductive compound has a composition as in formula (IV), Q is a bivalent cation, M is a trivalent cation, x is 8-22, y is 0.1-3, w is 0-3, z is 0.1-3, u is 7-20, and t is 0-8. In some such embodiments, the ionically conductive compound may have a composition as in formula (XXI):

Li_{2x-3y+2+3w-t}M_{y-z}Q_{w}P_{2-w}S_{x+6-1.5z-t}Xₜ (XXI),

wherein x is 8-22, y is 0.1-3, w is 0-3, z is 0.1-3, u is 7-20, t is 0-8, wherein X is absent or selected from the group consisting of halide and pseudohalide, wherein M is a trivalent cation, and wherein Q is a bivalent cation, such that 2x−3y+2+3w−t is 8-22, y−z is 0.1-3, 2−w is 0.1-3, and/or x+6−1.5z−t is 7-0. In some cases, the composition as in formula (XXI) may have an argyrodite-type crystal structure.

In certain embodiments, the ionically conductive compound has a composition as in formula (IV), M is a trivalent cation, Q is a trivalent cation, x is 8-22, y is 0.1-3, w is 0-3, z is 0.1-3, u is 7-20, and t is 0-8. In some such embodiments, the ionically conductive compound may have a composition as in formula (XXII):

Li_{2x-3y+2+2w-t}M_{y-z}Q_{w}P_{2-w}S_{x+6-1.5z-t}Xₜ (XXII),

wherein x is 8-22, y is 0.1-3, w is 0-3, z is 0.1-3, u is 7-20, t is 0-8, wherein X is absent or selected from the group consisting of halide and pseudohalide, wherein M is a trivalent cation, and wherein Q is a trivalent cation, such that 2x−3y+2+2w−t is 8-22, y−z is 0.1-3, 2−w is 0.1-3, and/or x+6−1.5z−t is 7-20. In some cases, the composition as in formula (XXII) may have an argyrodite-type crystal structure.

In some embodiments, the ionically conductive compound has a composition as in formula (IV), Q is a tetravalent cation, M is a trivalent cation, x is 8-22, y is 0.1-3, w is 0-3, z is 0.1-3, u is 7-20, and t is 0-8. In some such embodiments, the ionically conductive compound may have a composition as in formula (XXIII):

Li_{2x-3y+2+w-t}M_{y-z}Q_{w}P_{2-w}S_{x+6-1.5z-t}Xₜ (XXIII),

wherein x is 8-22, y is 0.1-3, w is 0-3, z is 0.1-3, u is 7-20, t is 0-8, wherein X is absent or selected from the group consisting of halide and pseudohalide, wherein M is a trivalent cation, and wherein Q is a tetravalent cation, such that 2x−3y+2+w−t is 8-22, y−z is 0.1-3, 2−w is 0.1-3, and/or x+6−1.5z−t is 7-20. In some cases, the composition as in formula (XXIII) may have an argyrodite-type crystal structure.

In certain embodiments, the ionically conductive compound has a composition as in formula (IV), M is a trivalent cation, Q is a pentavalent cation, x is 8-22, y is 0.1-3, w is 0-3, z is 0.1-3, u is 7-20, and t is 0-8. In some such embodiments, the ionically conductive compound may have a composition as in formula (XXIV):

Li_{2x-3y+2-t}M_{y-z}Q_{w}P_{2-w}S_{x+6-1.5z-t}Xₜ (XXIV),

wherein x is 8-22, y is 0.1-3, w is 0-3, z is 0.1-3, u is 7-20, t is 0-8, wherein X is absent or selected from the group consisting of halide and pseudohalide, wherein M is a trivalent cation, and wherein Q is a pentavalent cation, such that 2x−3y+2−t is 8-22, y−z is 0.1-3, 2−w is 0.1-3, and/or x+6−1.5z−t is 7-20. In some cases, the composition as in formula (XXIV) may have an argyrodite-type crystal structure.

In some embodiments, the ionically conductive compound has a composition as in formula (IV), Q is absent, M is a tetravalent cation, x is 8-22, y is 0.1-3, w is 0-3, z is 0.1-3, u is 7-20, and t is 0-8. In some such embodiments, the ionically conductive compound may have a composition as in formula (XXV):

Li_{2x-4y+2-t}M_{y-z}P₂S_{x+6-2z-t}Xₜ (XXV),

wherein x is 8-22, y is 0.1-3, w is 0-3, z is 0.1-3, u is 7-20, t is 0-8, wherein X is absent or selected from the group consisting of halide and pseudohalide, and wherein M is a tetravalent cation, such that 2x−4y+2−t is 8-22, y−z is 0.1-3, and/or x+6−2z−t is 7-20. In some cases, the composition as in formula (XXV) may have an argyrodite-type crystal structure.

In certain embodiments, the ionically conductive compound has a composition as in formula (IV), M is a tetravalent cation, Q is a monovalent cation, x is 8-22, y is 0.1-3, w is 0-3, z is 0.1-3, u is 7-20, and t is 0-8. In some such embodiments, the ionically conductive compound may have a composition as in formula (XXVI):

Li_{2x-4y+2+4w-t}M_{y-z}Q_{w}P_{2-w}S_{x+6-2z-t}Xₜ (XXVI),

wherein x is 8-22, y is 0.1-3, w is 0-3, z is 0.1-3, u is 7-20, t is 0-8, wherein X is absent or selected from the group consisting of halide and pseudohalide, wherein M is a tetravalent cation, and wherein Q is a monovalent cation, such that 2x−4y+2+4w−t is 8-22, y−z is 0.1-3, 2−w is 0.1-3, and/or x+6−2z−t is 7-20. In some cases, the composition as in formula (XXI) may have an argyrodite-type crystal structure.

In some embodiments, the ionically conductive compound has a composition as in formula (IV), Q is a bivalent cation, M is a tetravalent cation, x is 8-22, y is 0.1-3, w is 0-3, z is 0.1-3, u is 7-20, and t is 0-8. In some such embodiments, the ionically conductive compound may have a composition as in formula (XXVII):

Li_{2x-4y+2+3w-t}M_{y-z}Q_{w}P_{2-w}S_{x+6-2z-t}Xₜ (XXVII),

wherein x is 8-22, y is 0.1-3, w is 0-3, z is 0.1-3, u is 7-20, t is 0-8, wherein X is absent or selected from the group consisting of halide and pseudohalide, wherein M is a tetravalent cation, and wherein Q is a bivalent cation, such that 2x−4y+2+3w−t is 8-22, y−z is 0.1-3, 2−w is 0.1-3, and/or x+6−2z−t is 7-20. In some cases, the composition as in formula (XXII) may have an argyrodite-type crystal structure.

In certain embodiments, the ionically conductive compound has a composition as in formula (IV), M is a tetravalent cation, Q is a trivalent cation, x is 8-22, y is 0.1-3, w is 0-3, z is 0.1-3, u is 7-20, and t is 0-8. In some such embodiments, the ionically conductive compound may have a composition as in formula (XXVIII):

Li_{2x-4y+2+2w-t}M_{y-z}Q_{w}P_{2-w}S_{x+6-2z-t}Xₜ (XXVIII),

wherein x is 8-22, y is 0.1-3, w is 0-3, z is 0.1-3, u is 7-20, t is 0-8, wherein X is absent or selected from the group consisting of halide and pseudohalide, wherein M is a tetravalent cation, and wherein Q is a trivalent cation, such that 2x−4y+2+2w−t is 8-22, y−z is 0.1-3, 2−w is 0.1-3, and/or x+6−2z−t is 7-20. In some cases, the composition as in formula (XXVIII) may have an argyrodite-type crystal structure.

In some embodiments, the ionically conductive compound has a composition as in formula (IV), Q is a tetravalent cation, M is a tetravalent cation, x is 8-22, y is 0.1-3, w is 0-3, z is 0.1-3, u is 7-20, and t is 0-8. In some such embodiments, the ionically conductive compound may have a composition as in formula (XXIX):

Li_{2x-4y+2+w-t}M_{y-z}Q_{w}P_{2-w}S_{x+6-2z-t}Xₜ (XXIX),

wherein x is 8-22, y is 0.1-3, w is 0-3, z is 0.1-3, u is 7-20, t is 0-8, wherein X is absent or selected from the group consisting of halide and pseudohalide, wherein M is a tetravalent cation, and wherein Q is a tetravalent cation, such that 2x−4y+2+w−t is 8-22, y−z is 0.1-3, 2−w is 0.1-3, and/or x+6−2z−t is 7-20. In some cases, the composition as in formula (XXIX) may have an argyrodite-type crystal structure.

In certain embodiments, the ionically conductive compound has a composition as in formula (IV), M is a tetravalent cation, Q is a pentavalent cation, x is 8-22, y is 0.1-3, w is 0-3, z is 0.1-3, u is 7-20, and t is 0-8. In some such embodiments, the ionically conductive compound may have a composition as in formula (XXX):

Li_{2x-4y+2-t}M_{y-z}Q_{w}P_{2-w}S_{x+6-2z-t}Xₜ (XXX),

wherein x is 8-22, y is 0.1-3, w is 0-3, z is 0.1-3, u is 7-20, t is 0-8, wherein X is absent or selected from the group consisting of halide and pseudohalide, wherein M is a tetravalent cation, and wherein Q is a pentavalent cation, such that 2x−4y+2−t is 8-22, y−z is 0.1-3, 2−w is 0.1-3, and/or x+6−2z−t is 7-20. In some cases, the composition as in formula (XXX) may have an argyrodite-type crystal structure.

In an exemplary embodiment, the ionically conductive compound has a composition as in any one of formulas (IV)-(XXX) and Q and X are absent and the ionically conductive compound has a composition as in Li₂₂MP₂S₁₈, wherein M is a tetravalent cation. In another exemplary embodiment, Q and X are absent and the ionically conductive compound has a composition as in Li₁₈MP₂S₁₆, wherein M is a tetravalent cation. In another exemplary embodiment, Q and X are absent and the ionically conductive compound has a composition as in Li₁₄MP₂S₁₄, wherein M is a tetravalent cation. In another exemplary embodiment, Q and X are absent and the ionically conductive compound has a composition as in Li₁₂MP₂S₁₂, wherein M is a tetravalent cation. In yet another exemplary embodiment, Q and X are absent and the ionically conductive compound has a composition as in Li₁₀MP₂S₁₂, wherein M is a tetravalent cation. In yet another exemplary embodiment, the ionically conductive compound has a composition as in Li₁₄M₂P₂S_{13.5}, wherein M is a tetravalent cation.

In an exemplary embodiment, the ionically conductive compound has a composition as in any one of formulas (IV)-(XXX) and Q is absent and the ionically conductive compound has a composition as in Li₁₃MP₂S₁₃Cl. In another exemplary embodiment, Q is absent and the ionically conductive compound has a composition as in Li₁₂MP₂S₁₂Cl₂. In yet another exemplary embodiment, Q is absent and the ionically conductive compound has a composition as in Li₁₁MP₂S₁₁Cl₃. In yet another exemplary embodiment, Q is absent and the ionically conductive compound has a composition as in Li₁₂MP₂S₁₁Br₃.

Non-limiting examples of compounds having a composition as in formula (IV) include Li₁₀FeP₂S₁₂, Li₁₁FeP₂S₁₁Cl₃, Li_{12.5}Fe_{0.75}P₂S₁₂, Li_{13.5}Fe_{0.75}P₂S_{12.25}, Li₁₃Fe_{0.5}P₂S₁₂, Li₁₃Fe_{0.75}P₂S_{12.25}, Li₁₃FeP₂S_{12.5}, Li_{14.5}Fe_{0.75}P₂S₁₃, Li₁₄Fe_{0.5}P₂S_{12.5}, Li₁₄Fe_{0.75}P₂S_{12.75}, Li₁₄FeP₂S₁₃, Li₁₅Fe_{0.5}P₂S₁₃, Li₂₂FeP₂S₁₈, Li₁₈FeP₂S₁₆, Li₁₄FeP₂S₁₄, Li₁₂FeP₂S₁₂, Li₁₀FeP₂S₁₂, Li₁₄Fe₂PS_{13.5}, Li₁₃FeP₂S₁₃Cl, Li₁₂FeP₂S₁₂Cl₂, and Li₁₃FeP₂S₁₃Br.

In certain embodiments, a layer comprising the compound of formula (IV) (or one or more of the compounds for formulas (V)-(XXX))) as described herein, is substantially crystalline. In certain embodiments, the layer comprising the compound of formula (IV) (or one or more of the compounds for formulas (IV)-(XXX)) is between 1 wt % and 100 wt % crystalline. That is to say, in some embodiments, the crystalline fraction of the compound of formula (IV) comprised by the layer is in the range of 1% to 100% based on the total weight of the compound of formula (IV) comprised by the layer (or particles). In certain embodiments, the layer comprising the compound of formula (IV) (or one or more of the compounds for formulas (V)-(XXX)) is greater than or equal to 1 wt %, greater than or equal to 2 wt %, greater than or equal to 5 wt %, greater than or equal to 10 wt %, greater than or equal to 20 wt %, greater than or equal to 25 wt %, greater than or equal to 50 wt %, greater than or equal to 75 wt %, greater than or equal to 90 wt %, greater than or equal to 95 wt %, greater than or equal to 98 wt %, greater than or equal to 99 wt %, or greater than or equal to 99.9 wt % crystalline. In certain embodiments, the layer comprising the compound of formula (IV) is less than or equal to 99.9 wt %, less than or equal to 98 wt %, less than or equal to 95 wt %, less than or equal to 90 wt %, less than or equal to 75 wt %, less than or equal to 50 wt %, less than or equal to 25 wt %, less than or equal to 20 wt %, less than or equal to 10 wt %, less than or equal to 5 wt %, or less than or equal to 2 wt % crystalline.

In some embodiments, a layer comprising the compound of formula (IV) (or one or more of the compounds for formulas (V)-(XXX)) is greater than or equal to 99.2 wt %, greater than or equal to 99.5 wt %, greater than or equal to 99.8 wt %, or greater than or equal to 99.9 wt % crystalline. In some cases, a layer comprising the compound of formula (IV) (or one or more of the compounds for formulas (V)-(XXX)) may be 100% crystalline. Combinations of the above referenced ranges are also possible (e.g., greater than or equal to 1 wt % and less than or equal to 100 wt %, greater than or equal to 50 wt % and less than or equal to 100 wt %).

When present, the ionically conductive compound may be fabricated and/or deposited onto a separator by sputtering (e.g., magnetron sputtering), ion beam deposition, molecular beam epitaxy, electron beam evaporation, vacuum thermal evaporation, aerosol deposition, sol-gel, laser ablation, chemical vapor deposition (CVD), thermal evaporation, plasma enhanced chemical vacuum deposition (PECVD), laser enhanced chemical vapor deposition, jet vapor deposition, etc. In some embodiments, a layer comprising a compound described herein is made by cold pressing. The technique used may depend on the desired thickness of the layer, the material being deposited on, etc. The ionically conductive may be deposited in powder form, in some cases. In some embodiments, particles comprising the ionically conductive compound may be deposited on a surface, such as a surface of a separator, and sintered.

As described above, certain embodiments relate to electrochemical cells comprising at least a first electrode and a second electrode. The electrochemical cell can be, according to certain embodiments, a rechargeable electrochemical cell (also sometimes referred to as a secondary electrochemical cell). The first electrode and the second electrode may have different electrode potentials such that electric current may flow spontaneously from one electrode to the other during discharge. It may be possible to charge a discharged electrochemical cell by applying an external potential.

In some embodiments, the first electrode may be an anode, or a species into which the electrode active material (e.g., lithium, sodium, magnesium) is integrated during charge and liberated from during discharge. The anode may be an intercalation anode, or an anode into which electrode active material intercalates during charge and de-intercalates during discharge. In some embodiments, the electrode active material is lithium and the first electrode is a lithium intercalation electrode, such as a lithium intercalation anode. In some embodiments, the electrode active material of the first electrode (e.g., an anode) comprises carbon. In certain cases, the electrode active material of the first electrode (e.g., an anode) is or comprises a graphitic material (e.g., graphite). A graphitic material generally refers to a material that comprises a plurality of layers of graphene (e.g., layers comprising carbon atoms arranged in a hexagonal lattice). Adjacent graphene layers are typically attracted to each other via van der Waals forces, although covalent bonds may be present between one or more sheets in some cases. In some cases, the carbon-comprising electrode active material of the anode is or comprises coke (e.g., petroleum coke). In certain embodiments, the electrochemical material of the first electrode (e.g., an anode) comprises silicon, germanium, boron, oxygen, lithium, and/or any alloys of combinations thereof. In certain embodiments, the electrode active material of the anode comprises lithium titanate (Li₄Ti₅O₁₂, also referred to as “LTO”), tin-cobalt oxide, or any combinations thereof.

In some embodiments, the electrode active material in the first electrode is sodium and the first electrode is a sodium intercalation electrode, such as a sodium intercalation anode. In some embodiments in which the first electrode is a sodium intercalation electrode, the electrode active material of the first electrode (e.g., an anode) comprises carbon. In certain cases, the electrode active material of the first electrode (e.g., an anode) is or comprises a graphitic material (e.g., graphite). In certain embodiments, the electrochemical material of the first electrode (e.g., an anode comprising sodium) comprises silicon, germanium, boron, oxygen, lithium, and/or any alloys of combinations thereof. In certain embodiments, the electrode active material of the anode comprises sodium titanate (Na₂Ti₃O₇), tin-cobalt oxide, or any combinations thereof.

In some embodiments, the electrode active material in the first electrode may comprise a metal. For example, in some embodiments the first electrode may be an anode that comprises one or more of lithium metal, sodium metal, and magnesium metal.

In some embodiments, the electrode active material in the first electrode may comprise an alloy. For example, in some embodiments the first electrode may be an anode that comprises one or more of a lithium alloy, a sodium alloy, and a magnesium alloy.

As would be understood by those of ordinary skill in the art, the first electrode can contain components other than the electrode active material. For example, in some embodiments, the first electrode contains one or more optional binders. In certain embodiments, the first electrode contains one or more conductive additives (e.g., carbon such as carbon black, metal particles, and the like).

In some embodiments, the second electrode is a cathode, or a species from which the electrode active material (e.g., lithium) is liberated during charge and into which electroactive material is integrated during discharge. The cathode may be an intercalation cathode, or a cathode from which an electrode active material de-intercalates during charge and into which an electrode active material intercalates during discharge. In some embodiments, the electrode active material is lithium and the second electrode is a lithium intercalation electrode such as a lithium intercalation cathode. The second electrode may comprise a lithium intercalation compound (e.g., a compound that is capable of reversibly inserting lithium ions at lattice sites and/or interstitial sites). In certain cases, the electrode active material of the second electrode comprises a layered oxide. A layered oxide generally refers to an oxide having a lamellar structure (e.g., a plurality of sheets, or layers, stacked upon each other). In some embodiments, the layered oxide may be a lithium transition metal oxide. Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}CO_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the electrode active material of the second electrode is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the electrode active material of the second electrode is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electrode active material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the electrode active material is sodium and the second electrode is a sodium intercalation electrode such as a sodium intercalation cathode. The second electrode may comprise a sodium intercalation compound (e.g., a compound that is capable of reversibly inserting sodium ions at lattice sites and/or interstitial sites). In certain cases, the electrode active material of the second electrode comprises a layered oxide as described above. Non-limiting examples of suitable sodium layered oxide cathodes include sodium iron phosphate cathodes and NaₓCoO₂ cathodes.

In some embodiments, the electrode active material is magnesium and the second electrode is a magnesium intercalation electrode such as a magnesium intercalation cathode. The second electrode may comprise a magnesium intercalation compound (e.g., a compound that is capable of reversibly inserting magnesium ions at lattice sites and/or interstitial sites). In certain cases, the electrode active material of the second electrode comprises a layered oxide as described above. Non-limiting examples of suitable magnesium layered oxide cathodes include cobalt layered oxides and vanadium layered oxides.

As would be understood by those of ordinary skill in the art, the second electrode can, optionally, contain components other than the electrode active material. For example, in some embodiments, the second electrode contains one or more optional binders. In certain embodiments, the second electrode contains one or more conductive additives (e.g., carbon such as carbon black, metal particles, and the like).

In some embodiments, an electrochemical cell as described herein may comprise an electrolyte. As would be known to one of ordinary skill in the art, an electrolyte is an electrochemical cell component through which ion transport occurs during electrochemical cell cycling. Electrolytes typically comprise materials that are ionically conductive, such as ionically conductive liquids (e.g., ionically conductive solutions comprising a solvent (which may or may not itself be ionically conductive) and dissolved ions), ionically conductive gels, and/or ionically conductive solids. In some such embodiments, ion transport may occur through these ion conductive materials. Electrolytes are typically electrically insulating. In some cases, a single electrochemical cell component, such as a solid electrolyte or a gel electrolyte, may be both an ionically conductive electrolyte and an electrically insulating separator (e.g., it may act as a barrier that inhibits or prevents contact and electron transport between two electrodes within the electrochemical cell). An electrolyte that is also a separator may be the only separator in the electrochemical cell, or an electrochemical cell may comprise both a separator that is not an electrolyte and an electrolyte that is also a separator. In other embodiments, the electrolyte does not act as a separator. Separators that are not electrolytes are typically electrochemical cell components that inhibit or prevent contact and electron transport between two or more electrodes but are not themselves ionically conductive. In some embodiments, separators that are not electrolytes are infiltrated with an electrolyte (e.g., a separator may have pores which are at least partially filled by an electrolyte) that provides a pathway for ions to traverse the separator. Composites described herein that comprise a separator may comprise either or both of a separator that is an electrolyte and a separator that is not electrolyte.

Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. patent application Ser. No. 12/312,764, filed May 26, 2009 and entitled “Separation of Electrolytes,” by Mikhaylik et al., which is incorporated herein by reference in its entirety.

In some embodiments, a liquid-containing electrolyte may be used in the electrochemical cells described herein. Generally, the choice of electrolyte will depend upon the chemistry of the electrochemical cell, and, in particular, the species of ion that is to be transported between electrodes in the electrochemical cell. Suitable electrolytes can comprise, in some embodiments, one or more ionic electrolyte salts to provide ionic conductivity and one or more liquid electrolyte solvents. Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes (e.g., 1,3-dioxolane), N-alkylpyrrolidones, bis(trifluoromethanesulfonyl)imide, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. In some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, poly(vinylidene fluoride-co-hexafluoropropylene), derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, between 90-95%, or between 10-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

The electrolyte can comprise one or more ionic electrolyte salts to provide ionic conductivity and one or more liquid electrolyte solvents, gel polymer materials, polymer materials, or liquid-containing materials. In some embodiments, one or more lithium salts (e.g., LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂, and lithium bis(fluorosulfonyl)imide (LiFSI)) can be included. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al. A range of concentrations of the ionic lithium salts in the solvent may be used such as from about 0.2 m to about 2.0 m (m is moles/kg of solvent). In some embodiments, a concentration in the range between about 0.5 m to about 1.5 m is used.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃S0₃⁻), bis (fluorosulfonyl)imide (N(FSO₂)₂⁻, bis (trifluoromethyl sulfonyl)imide ((CF₃SO₂)₂N⁻, bis (perfluoroethylsulfonyl)imide((CF₃CF₂SO₂)₂N⁻, and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

In some embodiments, the electrolyte comprises a nitrogen-containing compound. “Nitrogen-containing compounds”, in accordance with various exemplary embodiments of the invention, include compounds including an N—O (e.g., nitro) functional group and/or an amine functional group. An N—O functional group may be defined as a functional group comprising a nitrogen atom bonded to an oxygen atom. Accordingly, in some embodiments, the first passivating agent is a N—O containing compound. In accordance with various exemplary aspects of these embodiments, one or more nitrogen-containing compounds may include one or more inorganic nitrates, organic nitrates, inorganic nitrites, organic nitrites, nitro compounds, amines, and other compounds including monomers, oligomers and/or polymers selected from the group consisting of: polyethylene imine, polyphosphazene, polyvinylpyrolidone, polyacrylamide, polyaniline, polyelectrolytes (e.g., having a nitro aliphatic portion as functional group), and amine groups, such as polyacrylamide, polyallylamine and polydiallyldimethylammonium chloride, polyimides, polybenzimidazole, polyamides, and the like. In some embodiments, the first passivating agent is a nitrogen-containing compound that is a non-solvent. In some embodiments, the first passivating agent is a nitrogen-containing compound that does not contain a nitrile group.

Examples of inorganic nitrates that may be used include, but are not limited to: lithium nitrate, sodium nitrate, potassium nitrate, calcium nitrate, cesium nitrate, barium nitrate, and ammonium nitrate. Examples of organic nitrates that may be used include, but are not limited to, pyridine nitrate, guanidine nitrate, and dialkyl imidazolium nitrates. By way of specific examples, a nitrate for use as the nitrogen-containing compound may be selected from the group consisting of lithium nitrate, sodium nitrate, potassium nitrate, calcium nitrate, cesium nitrate, barium nitrate, ammonium nitrate, pyridine nitrate, propyl nitrate, isopropyl nitrate and dialkyl imidazolium nitrates. The nitrate may be lithium nitrate and/or pyridine nitrate. The inorganic nitrate(s), if present, may be present in an amount described herein for a first passivating agent. The organic nitrate(s), if present, may be present in an amount described herein for a first passivating agent.

Examples of inorganic nitrites that may be used include, but are not limited to: lithium nitrite, sodium nitrite, potassium nitrite, calcium nitrite, cesium nitrite, barium nitrite, and ammonium nitrite. Examples of organic nitrites that may be used include, but are not limited to, ethyl nitrite, propyl nitrite, isopropyl nitrite, butyl nitrite, pentyl nitrite, and octyl nitrite. By way of specific examples, a nitrite for use as the nitrogen-containing compound may be selected from the group consisting of lithium nitrite, sodium nitrite, potassium nitrite, calcium nitrite, cesium nitrite, barium nitrite, ammonium nitrite and ethyl nitrite. The nitrite may be lithium nitrite.

Examples of nitro compounds that may be used include, but are not limited to: nitromethane, nitropropane, nitrobutanes, nitrobenzene, dinitrobenzene, nitrotoluene, dinitrotoluene, nitropyridine, dinitropyridine.

Examples of other organic N—O compounds that may be used include, but are not limited to pyridine N-oxide, alkylpyridine N-oxides, and tetramethyl piperidine N-oxyl (TEMPO).

The nitrogen-containing material may be a soluble compound (e.g., a compound soluble in the electrolyte), such as certain inorganic nitrates, organic nitrates, inorganic nitrites, organic nitrites, nitro compounds, amines, and other compounds as set forth above. Or, the nitrogen-containing material may be a substantially insoluble compound in the electrolyte. As used herein, “substantially insoluble” means less than 1 wt % or less than 0.5 wt % solubility of the compound in the electrolyte; all percents set forth herein are weight or mass percent, unless otherwise noted.

Substantially insoluble compounds can be formed by, for example, attaching an insoluble cation, monomer, oligomer, or polymer, such as polystyrene or cellulose, to a nitrogen-containing compound to form polynitrostyrene or nitrocellulose. One such substantially insoluble compound is octyl nitrate. Additionally or alternatively, compounds, such as salts of K, Mg, Ca, Sr, Al, aromatic hydrocarbons, or ethers such as butyl ether may be added to the electrolyte to reduce the solubility of nitrogen-containing compounds, such as inorganic nitrates, organic nitrates, inorganic nitrites, organic nitrites, organic nitro compounds, and the like, such that otherwise soluble or mobile nitrogen-containing materials become substantially insoluble and/or substantially immobile in the electrolyte.

Another approach to reducing the mobility and/or solubility of nitrogen-containing materials, to form substantially insoluble nitrogen-containing compounds, includes attaching an N—O (e.g., nitro) and/or amine functional group to a long carbon chain, having, for example, about 8 to about 25 carbon atoms, to form micellar-type structures, with the active groups (e.g., nitrates) facing the electrolyte solution.

In some embodiments, the use of certain composites and/or methods described herein may result in improved capacity after repeated cycling of the electrochemical cell. For example, in some embodiments, after alternatively discharging and charging the cell three times, the cell exhibits at least about 50%, at least about 80%, at least about 90%, or at least about 95% of the cell's initial capacity at the end of the third cycle. In some cases, after alternatively discharging and charging the cell ten times, the cell exhibits at least about 50%, at least about 80%, at least about 90%, or at least about 95% of the cell's initial capacity at the end of the tenth cycle. In still further cases, after alternatively discharging and charging the cell twenty-five times, the cell exhibits at least about 50%, at least about 80%, at least about 90%, or at least about 95% of the cell's initial capacity at the end of the twenty-fifth cycle. In some embodiments, the electrochemical cell has a capacity of at least 20 mAh at the end of the cell's third, 10th, 25th, 30th, 40th, 45th, 50th, or 60th cycle.

The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; and U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”.

The following examples are intended to illustrate certain embodiments of the present invention, but do not exemplify the full scope of the invention.

### EXAMPLE 1

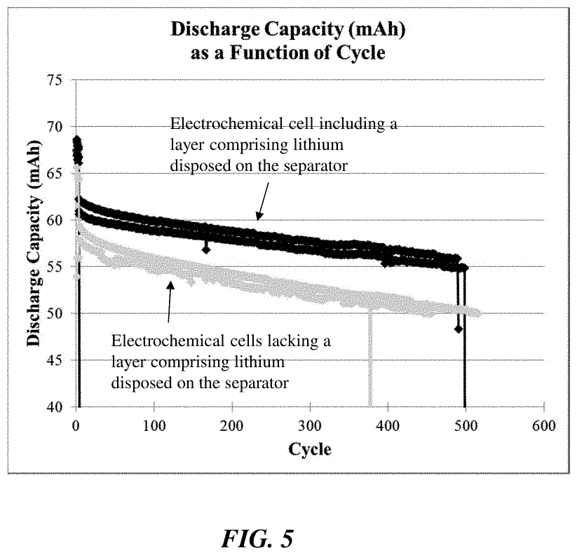

An electrochemical cell including a composite comprising a separator and comprising a layer comprising lithium was fabricated and compared to an otherwise identical electrochemical cell including a separator but lacking the layer comprising lithium. The discharge capacity as a function of cycle life was measured for both cells, as shown in FIG. 5. The cell including the composite comprising a separator and comprising a layer comprising lithium had a higher discharge capacity than the otherwise identical electrochemical cell including the separator but lacking the layer comprising lithium.

### EXAMPLE 2

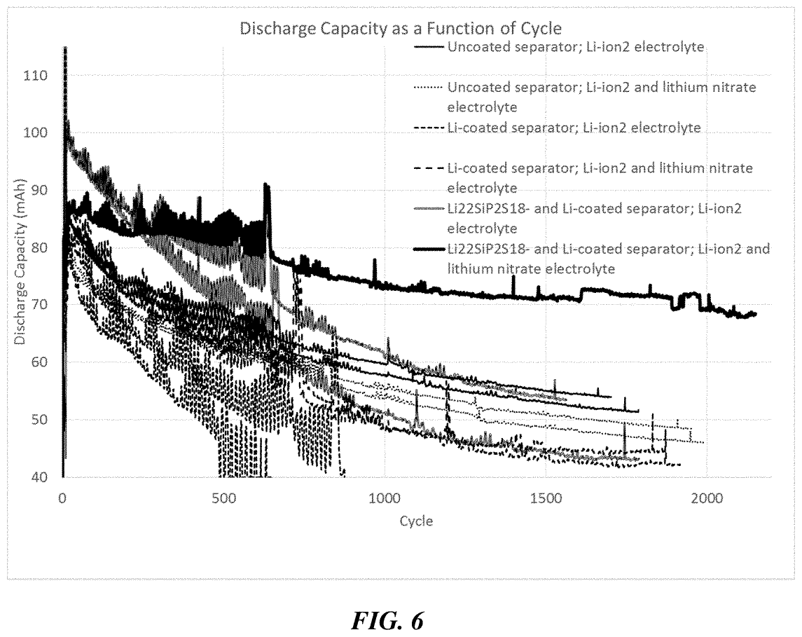

The effects of composite design and electrolyte composition on electrochemical cell performance were assessed. Electrochemical cells were fabricated that included a graphite first electrode, a lithium iron phosphate second electrode, carbonate Li-ion2 electrolyte, and either a Celgard Tri-Layer separator or a composite. The Li-ion2 electrolyte included 44.1 wt % ethylene carbonate, 44.1 wt % dimethyl carbonate, and 11.8 wt % LiPF₆. In some electrochemical cells, the electrolyte further comprised lithium nitrate. In electrochemical cells including a composite, one of the following two types of composites was included: (1) a composite formed by depositing a thin layer of lithium directly onto a Celgard Tri-Layer separator by electron bean evaporation; and (2) a composite formed by depositing a 1-2 micron thick layer of Li₂₂SiP₂S₁₈ directly onto a Celgard Tri-Layer separator by aerosol deposition and then depositing a thin layer of lithium onto the Li₂₂SiP₂S₁₈ by electron beam evaporation. FIG. 6 shows the discharge capacity as a function of cycle for each electrochemical cell tested. The electrochemical cells including the composite comprising both Li₂₂SiP₂S₁₈ and lithium had higher initial discharge capacities than other the other electrochemical cells. The electrochemical cell including lithium nitrate in the electrolyte and including the composite comprising both Li₂₂SiP₂S₁₈ and lithium had a longer cycle life than the other electrochemical cells.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrochemical cell, comprising:
a first electrode;
a second electrode; and
a composite comprising a separator and a layer comprising lithium disposed on a surface of the separator,
wherein:
the composite is positioned between the first electrode and the second electrode,
the layer comprising the lithium contains lithium in an amount of at least 50 wt %,
the layer comprising the lithium is adhered to the separator,
a surface of the layer facing away from the separator is passivated,
the first electrode is a lithium intercalation electrode, and
the second electrode is a lithium intercalation electrode.

2. An electrochemical cell, comprising:
a first electrode;
a second electrode; and
a composite comprising a polymeric electronically insulating separator and a layer comprising lithium disposed on a surface of the separator,
wherein:
the composite is positioned between the first electrode and the second electrode,
the layer comprising the lithium contains lithium in an amount of at least 50 wt %,
a surface of the layer facing away from the separator is passivated, and
the layer comprising the lithium is adhered to the separator.

3. (canceled)

4. An electrochemical cell as in claim 1, wherein the layer comprising the lithium comprises a passivation layer, and wherein the passivation layer has a thickness of less than or equal to 500 nm.

5. An electrochemical cell as in claim 1, wherein a binder makes up less than or equal to 20 wt % of the layer comprising the lithium.

6. An electrochemical cell as in claim 1, wherein particles make up less than or equal to 40 wt % of the layer comprising the lithium.

7. An electrochemical cell as in claim 1, wherein the layer comprising the lithium has a substantially uniform composition.

8. An electrochemical cell as in claim 1, wherein the layer comprising the lithium is a single phase material.

9. An electrochemical cell as in claim 1, wherein the layer comprising the lithium comprises lithium metal and/or a lithium alloy.

10. An electrochemical cell as in claim 1, wherein the layer comprising the lithium is a lithium metal layer containing at least 95 wt % lithium.

11. An electrochemical cell as in claim 1, wherein the surface of the separator on which the layer comprising the lithium is disposed is a surface of the separator closest to the first electrode.

12. An electrochemical cell as in claim 11, where the first electrode is an anode.

13. An electrochemical cell as in claim 1, wherein the surface of the separator on which the layer comprising the lithium is disposed is a surface of the separator closest to the second electrode.

14. An electrochemical cell as in claim 13, wherein the second electrode is a cathode.

15. An electrochemical cell as in claim 1, wherein the first electrode comprises graphite.

16. An electrochemical cell as in claim 1, wherein the second electrode comprises a lithium transition metal oxide.

17. An electrochemical cell as in claim 1, wherein the layer comprising the lithium has a thickness of greater than or equal to 0.5 microns and less than or equal to 5 microns.

18. An electrochemical cell as in claim 1, wherein the separator is a porous polymeric membrane.

19-22. (canceled)

23. A composite for use in an electrochemical cell, comprising:
a polymeric electronically insulating separator; and
a layer comprising lithium in an amount of at least 50 wt % disposed on a surface of the separator,
wherein the layer comprising the lithium is adhered to the separator, and wherein a surface of the layer facing away from the separator is passivated.

24-37. (canceled)

38. A method of fabricating an electrochemical cell, comprising:
positioning, between a first electrode and a second electrode, a composite comprising a separator and a layer comprising lithium disposed on a surface of the separator,
wherein:
the layer comprising the lithium contains lithium in an amount of at least 50 wt %,
a surface of the layer comprising the lithium is passivated, and
the layer comprising the lithium is adhered to the separator.

39-56. (canceled)
